(19) United States
(12) Patent Application Publication
(10) Pub. No.: US 2003/0228439 A1
(43) Pub. Date: Dec. 11, 2003

(54) Heat-sensitive recording material

(75) Inventor: Hiroshi Kawakami, Shizuoka-ken (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/446,833

(22) Filed: May 29, 2003

(30) Foreign Application Priority Data
May 30, 2002 (JP) 2002-157862

(51) Int. Cl. B32B 3/02

(52) U.S. Cl. 428/65.2

(57) ABSTRACT

The present invention provides a heat-sensitive recording material including a support having disposed thereon at least two heat-sensitive recording layers and an intermediate layer provided between the heat-sensitive recording layers, wherein the intermediate layer contains a compound having a fusing point or a softening point ranging from 40° C. to 200° C. and a particle size of 0.5 μm or smaller.

### BACKGROUND OF THE INVENTION

1. Field of the Invention

The present invention relates to a heat-sensitive recording material and, more particularly, to a heat-sensitive recording material having a plurality of heat-sensitive recording layers.

2. Description of the Related Art

In recent years, heat-sensitive recording processes have been developed since recording devices thereof are simple and highly reliable, and require no maintenance. Conventionally, as heat-sensitive recording materials for use in such processes, heat-sensitive recording materials utilizing a reaction between an electron-donating colorless dye and an electron-accepting compound and materials utilizing a reaction between a diazonium salt compound and a coupler have been widely known.

Usually, a heat-sensitive recording material which has a plurality of heat-sensitive recording layers, such as a multi-color heat-sensitive recording material, comprises an intermediate layer between the heat-sensitive recording layers. In order to reduce the cost of the heat-sensitive recording material, it is desirable that the intermediate layer is thin. However, if the layer is simply made thinner, the sensitivity of the heat-sensitive recording layer disposed under the intermediate layer may fluctuate, posing a problem of producing unbalanced sensitivity in relation to another heat-sensitive recording layer.

### SUMMARY OF THE INVENTION

It is an object of the present invention to provide a heat-sensitive recording material that achieves a reduction in cost by making an intermediate layer thinner, while properly maintaining the sensitivity of a heat-sensitive recording layer provided under the intermediate layer.

In order to solve the above-mentioned problem, the invention provides the following means. That is, the invention provides a heat-sensitive recording material comprising a support having disposed thereon at least two heat-sensitive recording layers and an intermediate layer provided between the heat-sensitive recording layers, wherein the intermediate layer contains a compound having a fusing point or a softening point ranging from 40° C. to 200° C. and a particle size of 0.5 μm or smaller.

### DETAILED DESCRIPTION OF THE INVENTION

Heat-Sensitive Recording Material

A heat-sensitive recording material of the present invention is characterized by comprising a support and having disposed thereon at least two heat-sensitive recording layers and an intermediate layer provided between the heat-sensitive recording layers (which may be of multiple colors or a single color), and characterized in that the intermediate layer contains a compound (hereinafter, sometimes referred to as “compound according to the invention”) having a fusing point or a softening point ranging from 40° C. to 200° C. and a particle size of 0.5 μm or smaller.

If the intermediate layer contains the compound according to the invention, it is possible for the layer to suitably maintain heat capacity even when a coated amount for forming the intermediate layer is small, and consequently, to be made thinner while properly maintaining sensitivity. Moreover, it is possible to suitably prevent warping during printing as well as after printing.

The invention will now be described in detail below.

Intermediate Layer

The intermediate layer in the heat-sensitive recording material of the invention contains the compound which has the fusing point or the softening point ranging from 40° C. to 200° C. and a particle size of 0.5 μm or smaller.

As used herein, the term “a fusing point or a softening point ranging from 40° C. to 200° C.” means that in case where the compound according to the invention is a low molecular compound, “the compound has the fusing point from 40° C. to 200° C.”, and in case where the compound is a high molecular compound, “the compound has the softening point from 40° C. to 200° C.”.

The fusing point or the softening point of the compound according to the invention is preferably from 80° C. to 200° C., and more preferably from 100° C. to 150° C.

If the fusing point or the softening point of the compound according to the invention is less than 40° C., fogging and discoloration may occur during storing of samples.

If the fusing point or the softening point of the compound according to the present invention exceeds 200° C., a desired heat capacity cannot be obtained since the compound is not fused by heat that is applied by a thermal head.

As used herein, the fusing point refers to a temperature at which fusing takes place within a narrow temperature range upon application of heat, and a solid phase and a liquid phase are in an equilibrium condition. This point is obtained by determining an endothermic quantity using DSC.

As used herein, the softening point refers to a temperature at which materials start to deform upon application of heat at a predetermined rate of temperature rise while applying a certain load. This point is obtained by determining an endothermic quantity using DSC.

Further, the compound according to the invention preferably has a heat of fusion or a latent heat of fusion of 80 J/g or greater, and more preferably of 100 J/g or greater. When the heat of fusion or the latent heat of fusion is 80 J/g or greater, the effect of the invention, that is, the thinner intermediate layer, can be sufficiently achieved without impairing the sensitivity of the heat-sensitive recording layer, and moreover, another effect of the invention, to prevent warping during printing as well as after printing, is also satisfactorily exhibited.

With respect to the compound according to the present invention having a particle size of 0.5 μm or smaller, examples thereof include: petroleum waxes such as paraffin wax and microwax; fatty-acid-based waxes such as zinc stearate, stearic acid amides and ethylenebis stearic acid amides; synthetic polymer waxes such as synthetic paraffin, polyethylene wax and polypropylene wax; vegetable waxes such as candelilla wax, carnauba wax, rice wax and Japan wax; beeswax and montan wax, and among these, fatty-acid-based waxes such as zinc stearate, stearic acid amide and ethylenebis stearic acid amides and synthetic polymer waxes such as synthetic paraffin, polyethylene wax and polypropylene wax, are preferably used, and zinc stearate and polyethylene wax having a softening point of 100° C. or higher are more preferably used.

As described above, the compound according to the present invention is characterized by having a particle size of 0.5 μm or smaller.

As used herein, the particle size refers to a volume-average primary particle size measured through a light-scattering method.

If the particle size of the compound according to the invention exceeds 0.5 μm, a uniform layer cannot be formed, resulting in poor transparency and deterioration of the coated surface state.

Thus, the compound according to the present invention is preferably designed to have a particle size of 0.5 μm or smaller, and more preferably of 0.3 μm or smaller.

The compound according to the invention is preferably contained in an amount of 10 to 200% by mass, and more preferably 20 to 100% by mass, relative to a binder in the intermediate layer, which will be described later.

When the compound according to the invention is contained in an amount of 10 to 200% by mass relative to the binder in the intermediate layer described later, the effects of the invention can be sufficiently exerted such that the intermediate layer may be made thinner without causing fluctuation in the sensitivity of a heat-sensitive recording layer and that warping during a printing process and after the printing process may be avoided.

As the binder to be used for the intermediate layer in the invention, conventionally known binders may be employed. Examples of the binder include: water-soluble polymers such as vinyl acetate/acrylic amide copolymer, polyvinyl alcohol, silicon-modified polyvinyl alcohol, carboxy-modified polyvinyl alcohol, alkyl-modified polyvinyl alcohol, starch, modified starch, methyl cellulose, carboxymethyl cellulose, hydroxylmethyl cellulose, gelatins, Arabic rubber, casein, hydrolysates of styrene/maleic acid copolymer, half-ester hydrolysates of styrene/maleic acid copolymer, hydrolysates of isobutylene/maleic anhydride copolymer, polyacrylamide derivatives, polyvinyl pyrrolidone, sodium polystyrenesulfonate and sodium alginate; synthetic rubber latexes such as styrene-butadiene rubber latex, acrylonitrile-butadiene rubber latex, methylacrylate-butadiene rubber latex and vinyl acetate emulsion; and synthetic resin emulsions; and among these, gelatins are preferably used.

Moreover, in addition to the compound and the binder relating to the invention, the intermediate layer of the invention may contain a pigment, a lubricant, a surfactant, a dispersant, a fluorescent brightener, metal soap, a UV absorbent, etc. Furthermore, in order to improve the film hardness of the heat-sensitive recording material, for example, a curing agent such as a crosslinking agent, e.g., boric acid that is capable of crosslinking with a binder, may be added to a coating solution for the intermediate layer.

Method for Forming Intermediate Layer

As the method for forming the intermediate layer of the invention, a method is employed in which the coating solution for the intermediate layer containing the compound according to the invention, a binder and the like is applied onto a heat-sensitive recording layer, which will be described later, using a device such as a bar coater, an air knife coater, a blade coater and a curtain coater, and then dried. Further, the coating solution for the intermediate layer may be applied simultaneously with the coating solution for the heat-sensitive recording layer, etc., through a simultaneous multilayer coating method, or after application of the heat-sensitive recording layer, the coating solution for the heat-sensitive recording layer is once dried, and the coating solution for the intermediate layer may be applied thereon. The coated amount of the intermediate layer after dried may preferably range from 1 to 5 g/m², and more preferably from 1.5 to 3 g/m². The coated amount of the intermediate layer after dried less than 1 g/m² may cause a mixed color print due to mixing among the heat-sensitive color-developing layers. On the other hand, the coated amount of the intermediate layer after dried exceeding 5 g/m² may impair the image quality.

Heat-Sensitive Recording Layer

The heat-sensitive recording material of the invention is preferably provided, as the photofixation-type heat-sensitive recording layer, with a photofixation-type heat-sensitive recording layer containing a diazonium salt compound having a maximum absorption wavelength of 365±40 nm and a coupler capable of reacting with the diazonium salt compound to develop color, and another photofixation-type heat-sensitive recording layer containing another diazonium salt compound having a maximum absorption wavelength of 425±40 nm and another coupler capable of reacting with the another diazonium salt compound to develop color.

Further, the invention is also applicable to a construction which includes a photofixation-type heat-sensitive recording layer containing a diazonium salt compound having a maximum absorption wavelength of less than 380 nm and a coupler capable of reacting with the diazonium salt compound to develop color, and another photofixation-type heat-sensitive recording layer containing another diazonium salt compound having a maximum absorption wavelength exceeding 390 nm and another coupler capable of reacting with the another diazonium salt compound to develop color.

It is also possible to produce a multi-color heat-sensitive recording material by changing hues of the respective photofixation-type heat-sensitive recording layers. In other words, by selecting the color-developing hues of the respective photofixation-type heat-sensitive recording layers as three primary colors in subtractive color mixing, that is, yellow, magenta and cyan, it becomes possible to carry out full-color image recording processes. In this case, the color-developing system in which the photofixation-type heat-sensitive recording layer is directly disposed on the support surface (as the lowermost layer of the photofixation-type heat-sensitive recording layers) is not limited to a combination of an electron-donating dye and an electron-accepting dye, but may be any system including a diazo color-developing system composed of a diazonium salt and a coupler that reacts with the diazonium salt to develop color, a base color-developing system that is devised to contact with a basic compound to develop color, a chelate color-developing system, and a color-developing system in which an elimination reaction is effected with a nucleophilic agent to develop color. And it is preferable to dispose two or more photofixation-type heat-sensitive recording layers, each of which contains respective diazonium salt compounds having mutually different maximum absorption wavelengths and respective couplers capable of reacting with the respective diazonium salt compounds to develop color.

As the color-developing component to be used in the photofixation-type heat-sensitive recording layer according to the invention, any of conventionally known components may be used. In particular, those utilizing a reaction between a diazonium salt compound and a coupler, or those utilizing a reaction between an electron-donating colorless dye and an electron-accepting compound are preferably used. For suitable use in the photofixation-type heat-sensitive recording layer upon application of heat to develop color, a diazonium salt compound, a coupler capable of reacting with the diazonium salt compound to form a dye; and a basic substance that accelerates the reaction between the diazonium salt compound and the coupler are set forth. These diazonium salt compounds, couplers and bases are disclosed in the following patent publications in detail: Japanese Patent Application Publication (JP-B) Nos. 4-75147, 6-55546, 6-79867, Japanese Patent Application Laid-Open (JP-A) Nos. 4-201483, 60-49991, 60-242094, 61-5983, 63-87125, 4-59287, 5-185717, 7-88356, 7-96671, 8-324129, 9-38389, 5-185736, 5-8544, 59-190866, 62-55190, 60-6493, 60-259492, 63-318546, 4-65291, 5-185736, 5-204089, 8-310133, 8-324129, 9-156229 and 9-175017. Specific examples will be shown below, however, the invention is not limited thereto.

(Specific Examples of Diazonium Salt Compound)

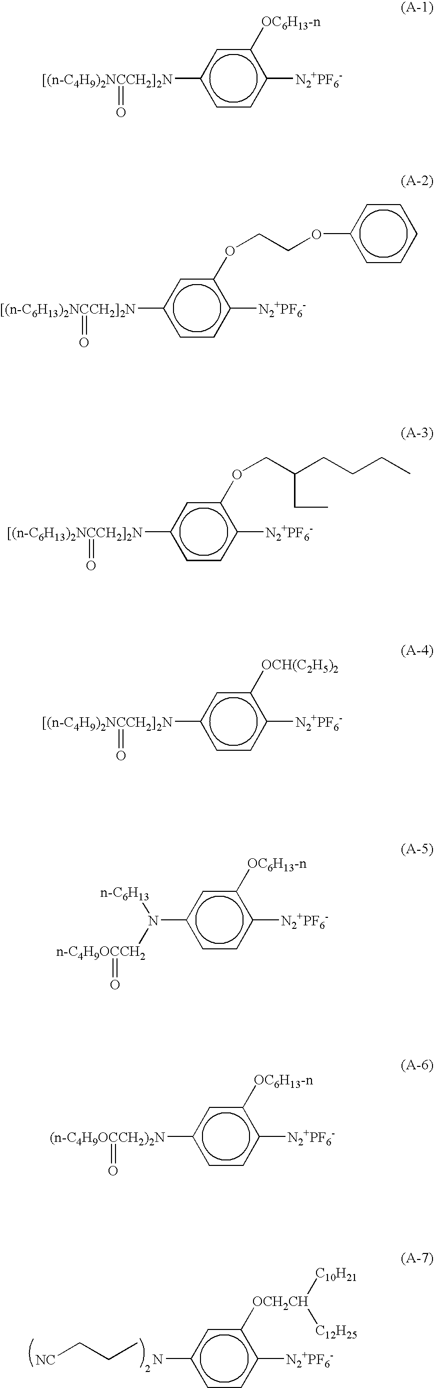

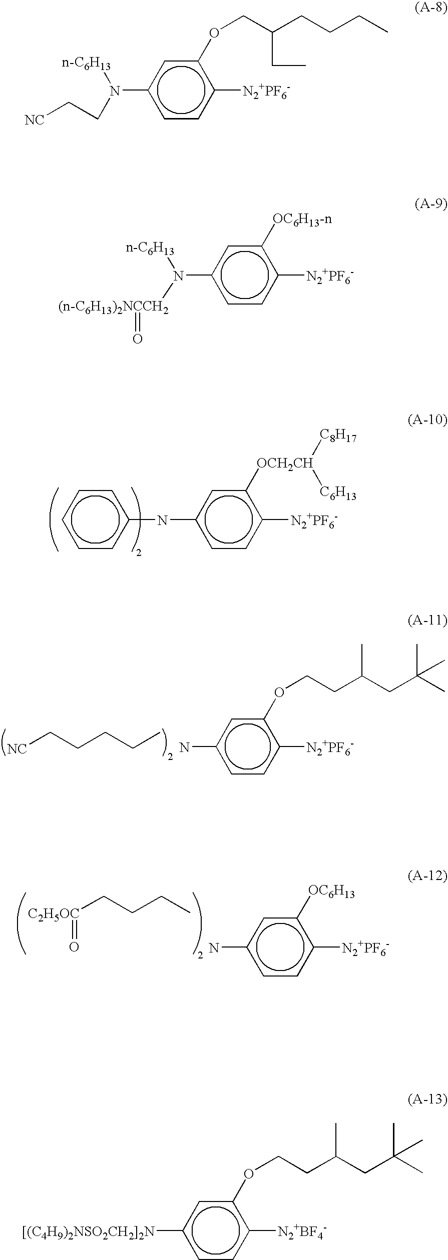

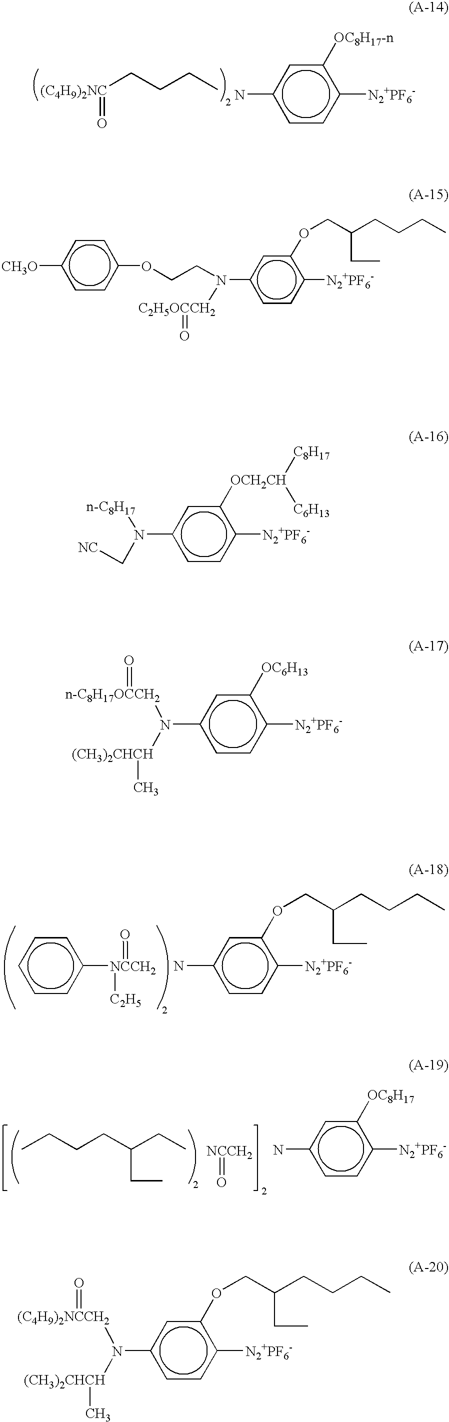

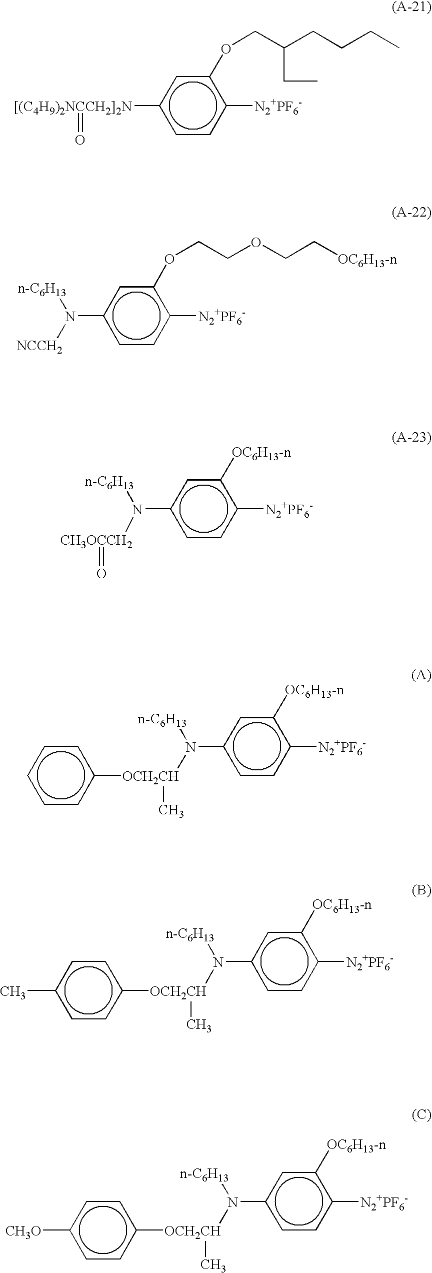

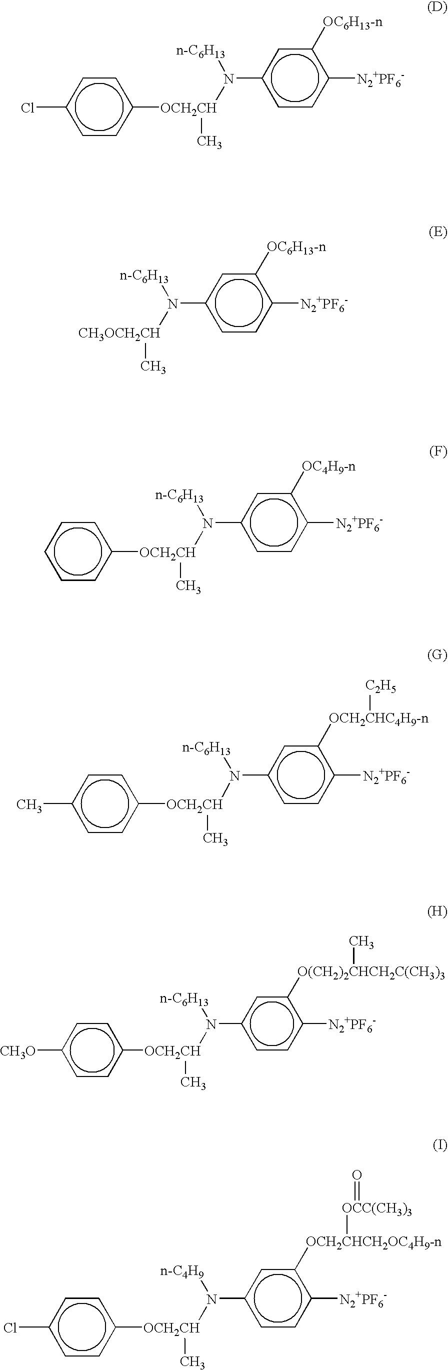

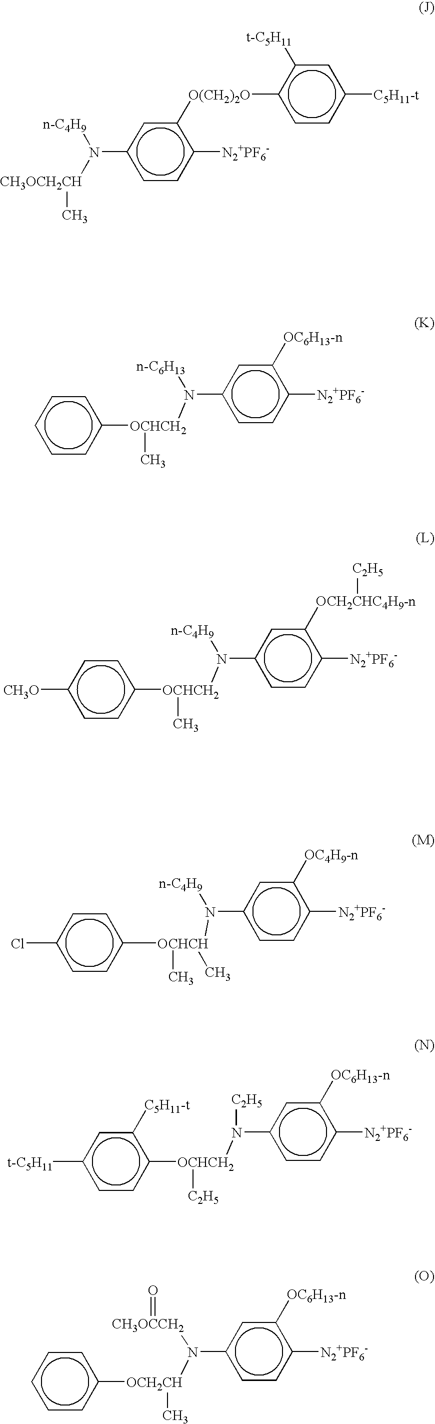

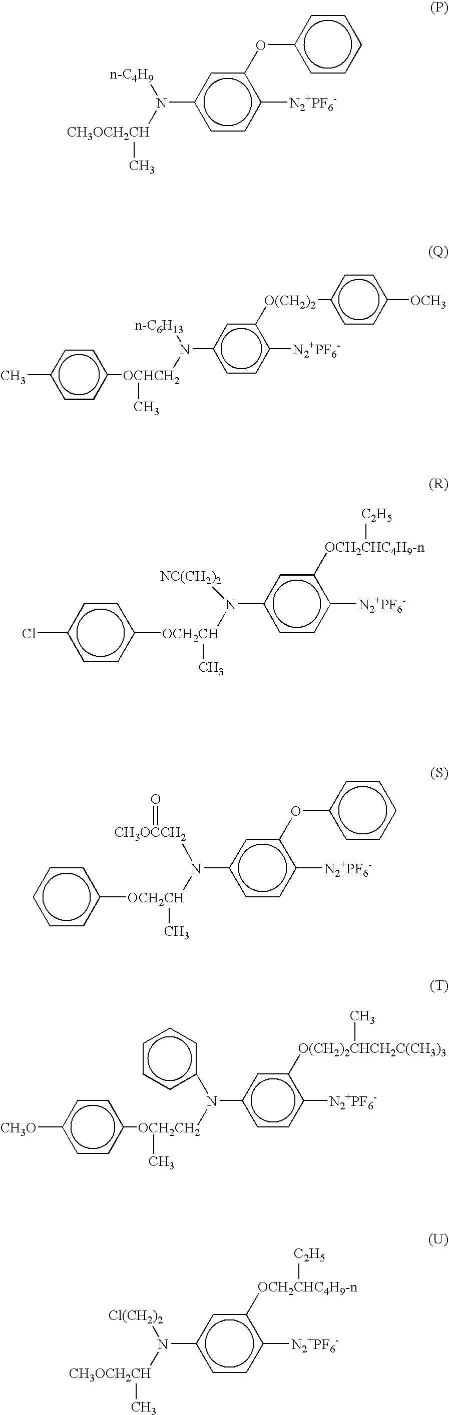

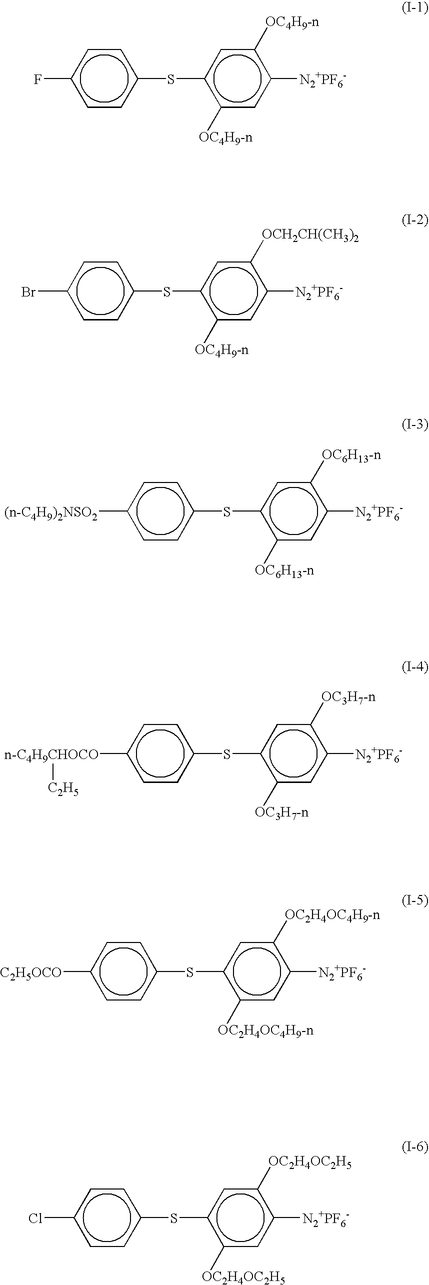

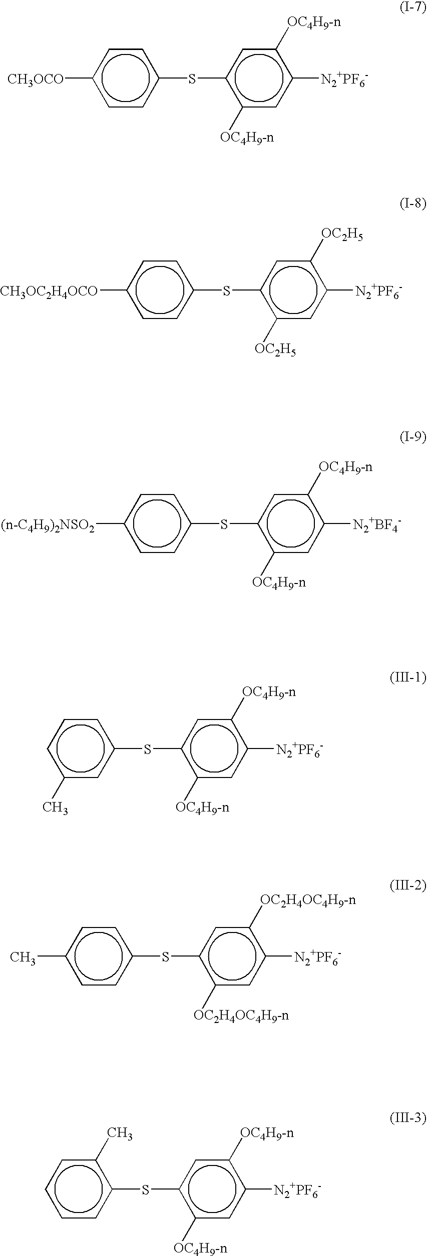

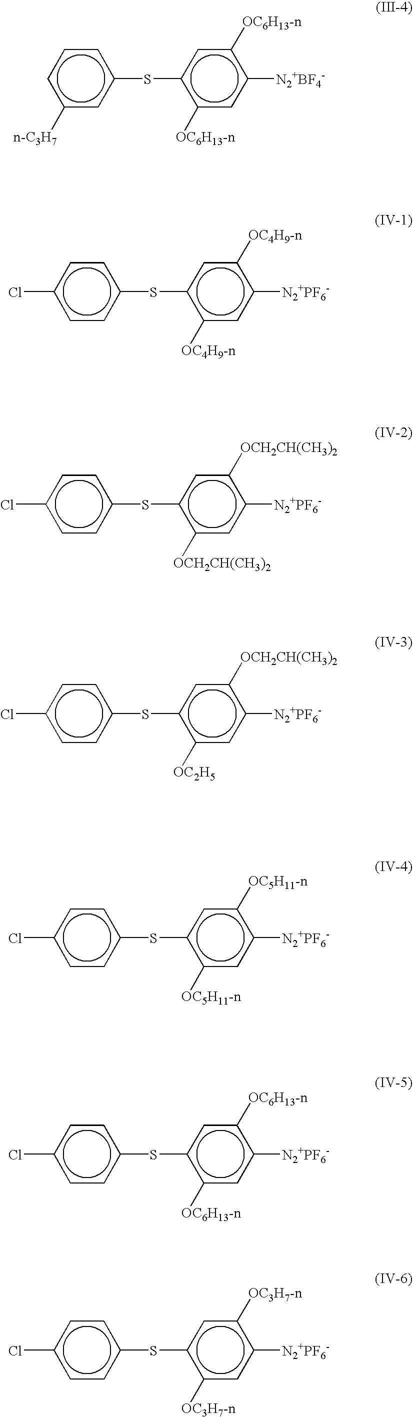

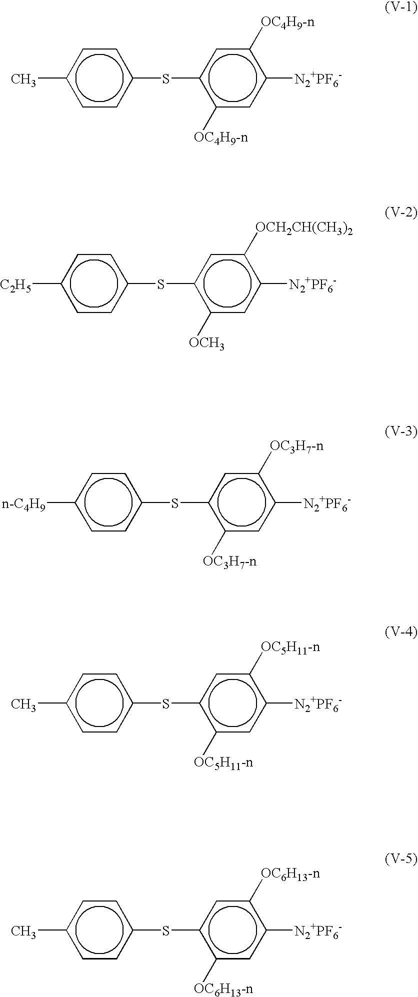

(Specific Examples of Coupler)

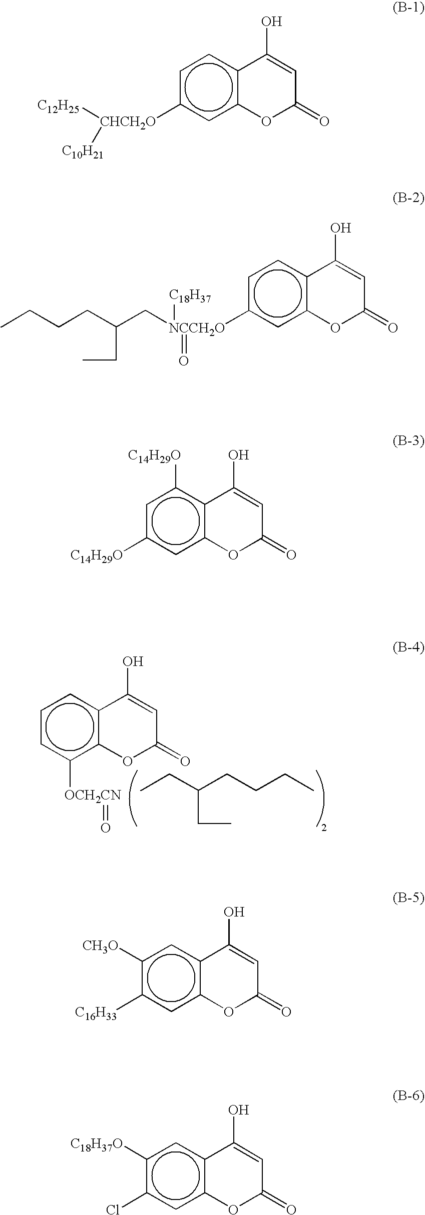

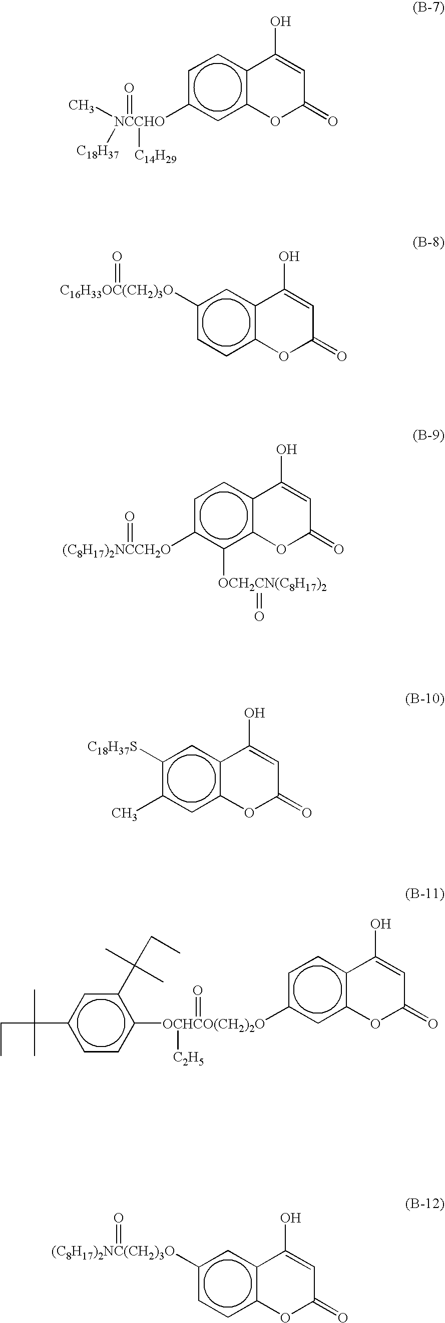

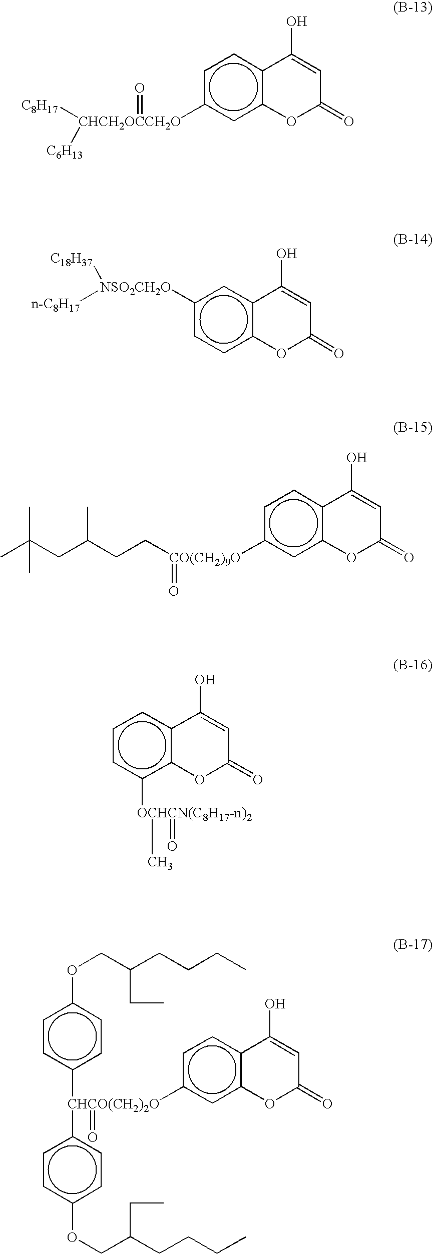

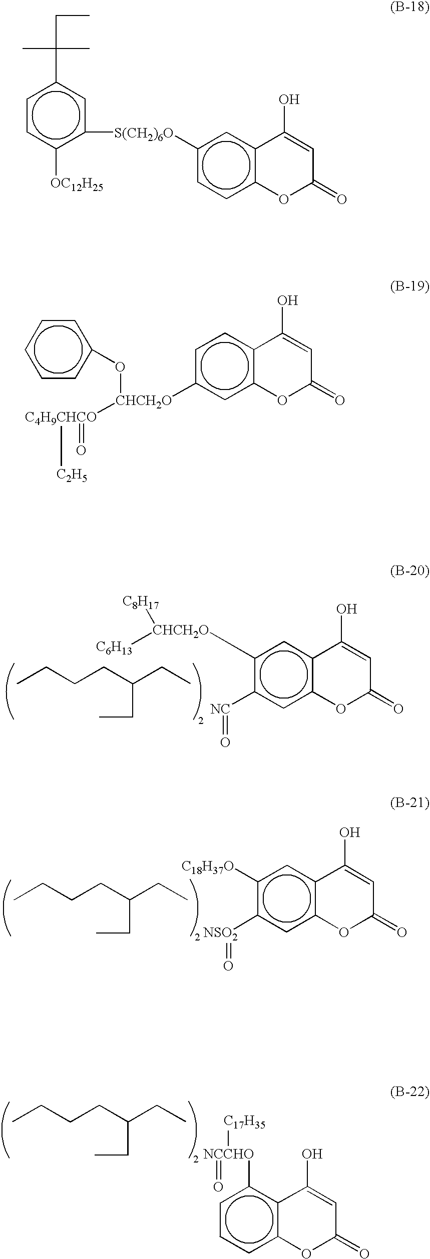

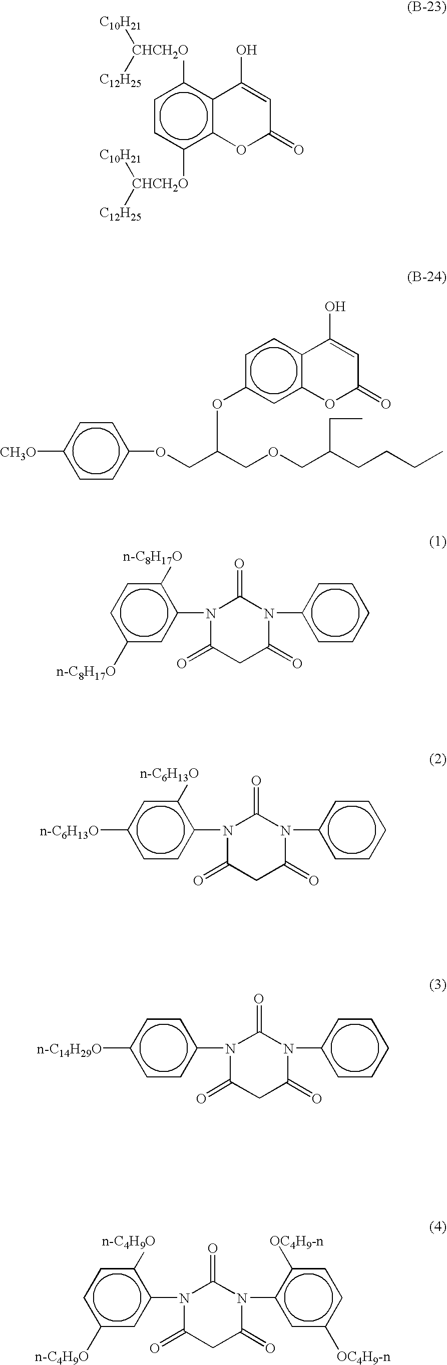

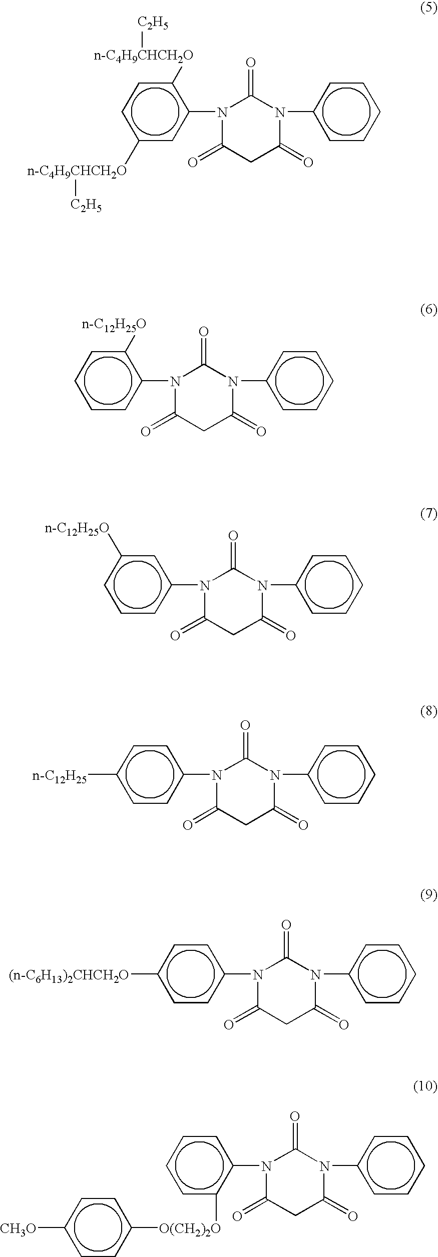

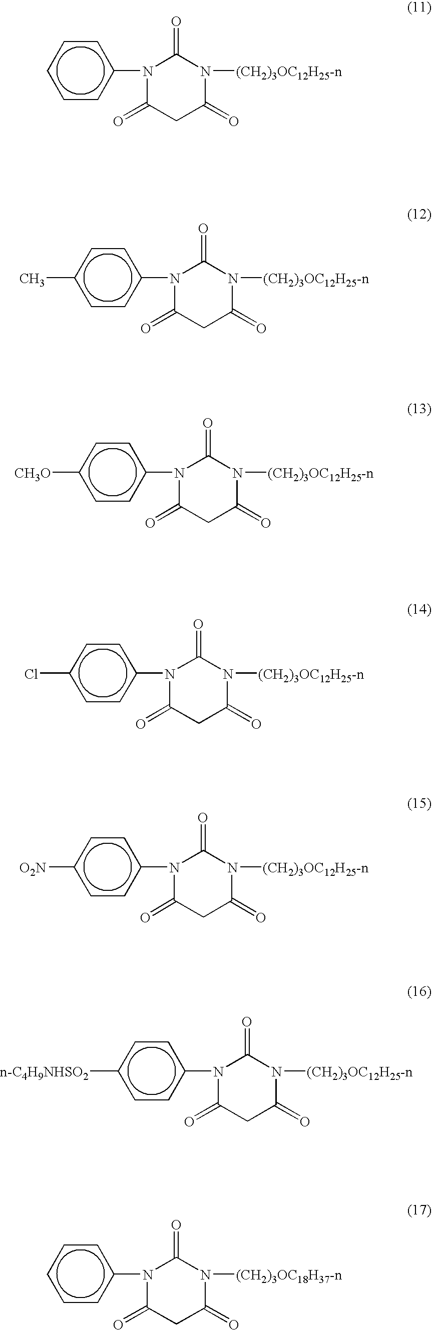

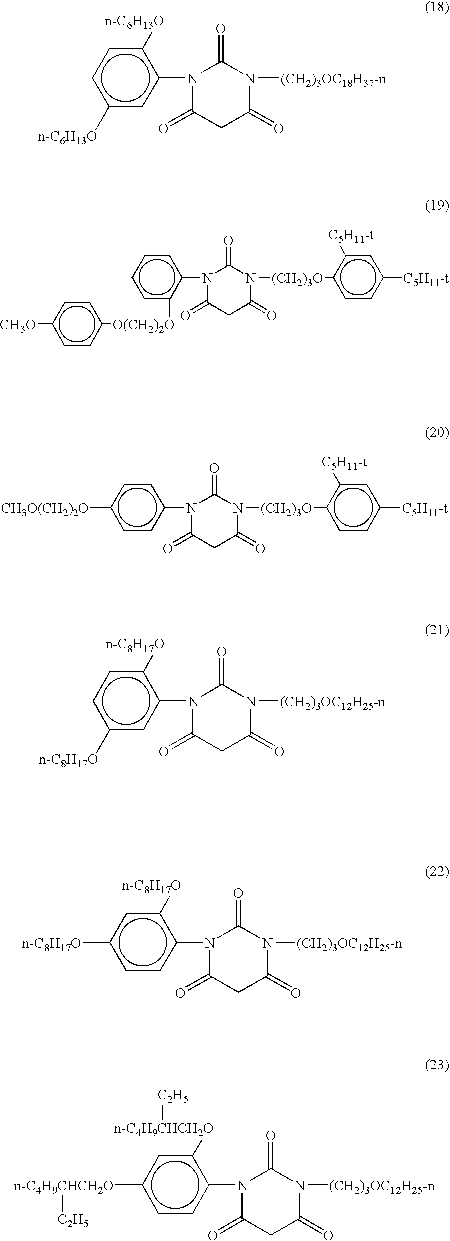

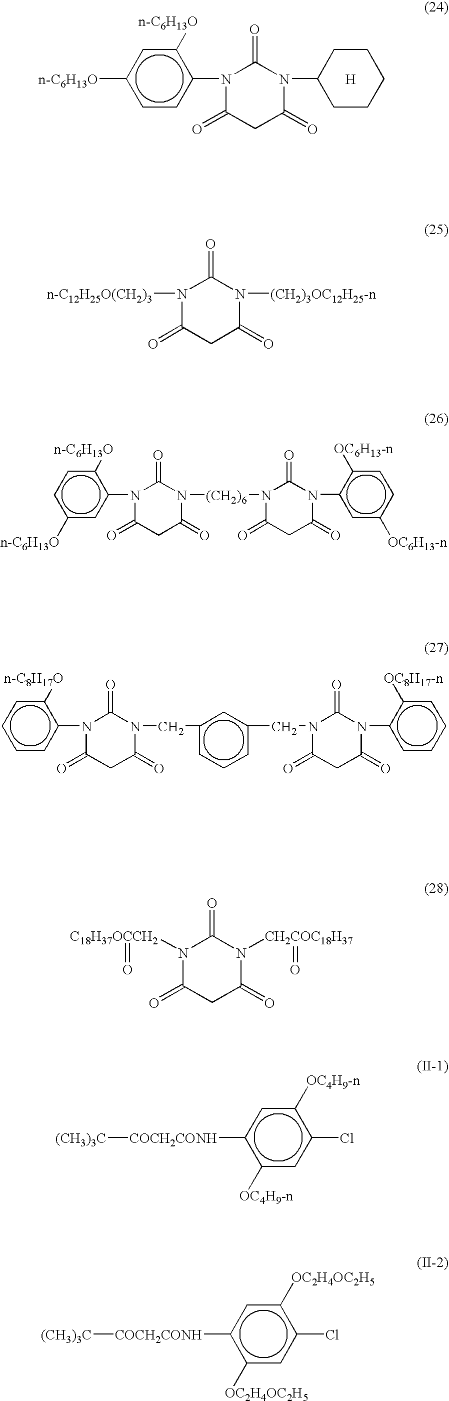

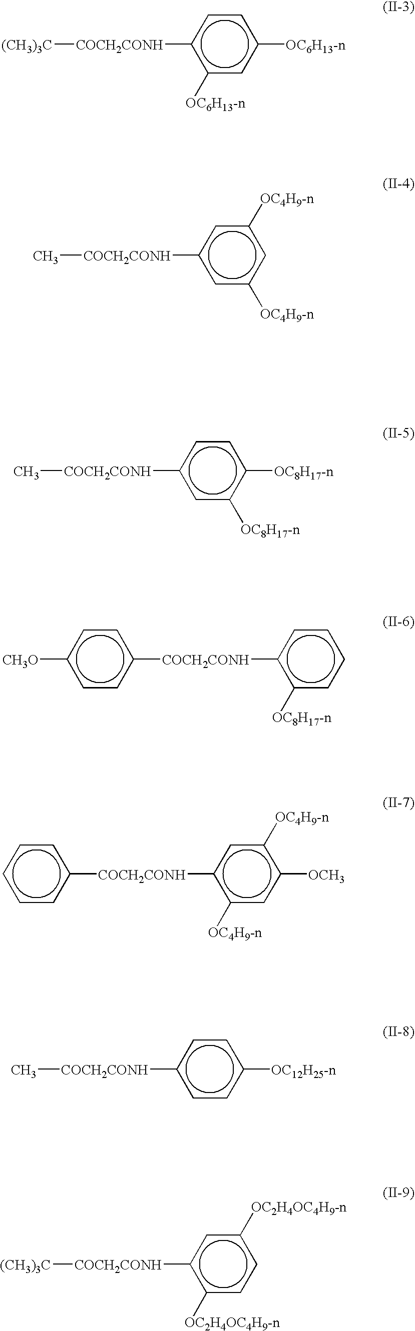

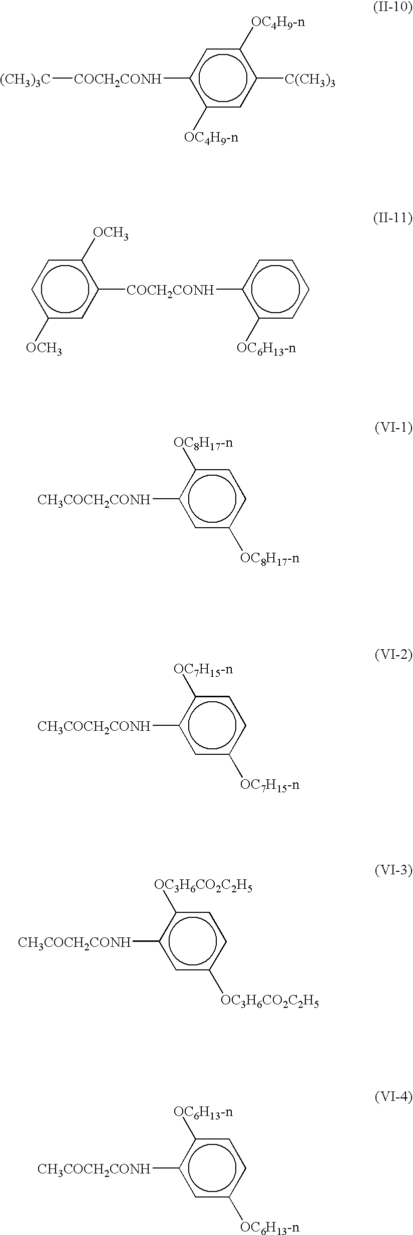

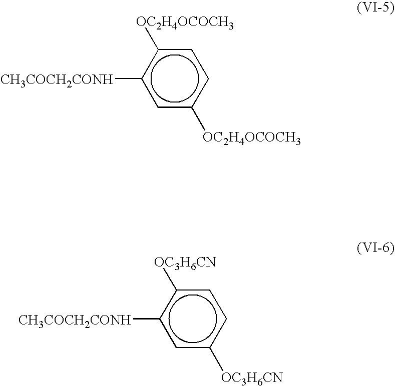

(Specific Examples of Base)

The above-described bases may be used alone, or in combination of two or more kinds thereof. Examples of the base include nitrogen-containing compounds such as tertiary amines, piperidines, piperazines, amidines, formamidines, pyridines, guanidines and morpholines.

Specific examples thereof include: piperazines such as N,N′-bis(3-phenoxy-2-hydroxylpropyl)piperazine, N,N′-bis(3-(p-methylphenoxy)-2-hydroxypropyl)piperazine, N,N′-bis(3-(p-methoxyphenoxy)-2-hydroxypropyl)piperazine, N,N′-bis(3-phenylthio-2-hydroxypropyl)piperazine, N,N′-bis(3-(β-naphthoxy)-2-hydroxypropyl)piperazine, N-3-(β-naphthoxy)-2-hydroxypropyl-N′-methylpiperazine and 1,4-bis((3-(N-methylpiperazino)-2-hydroxy)propyloxy)benzene; morpholines such as N-(3-(β-naphthoxy)-2-hydroxy)propylmorpholine, 1,4-bis((3-morpholino-2-hydroxy)propyloxy)benzene and 1,3-bis((3-morpholino-2-hydroxy)propyloxy)benzene; piperidines such as N-(3-phenoxy-2-hydroxypropyl)piperidine and N-dodecyl piperidine; guanidines such as triphenyl guanidine, tricyclohexyl guanidine and dicyclohexylphenyl guanidine.

Examples of the electron-donating colorless dye and the electron-accepting compound are detailed in the following patent publications: JP-A Nos. 6-328860, 7-290826, 7-314904, 8-324116, 3-37727, 9-31345, 9-111136, 9-118073 and 11-157221. Specific examples are shown below; however, the invention is not limited thereto.

(Specific Examples of Electron-Donating Colorless Dye)

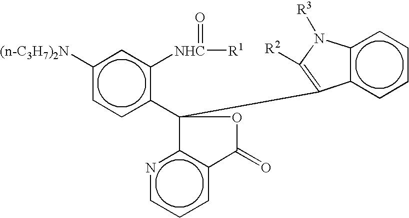

| | R¹ | R² | R³ |
|---|---|---|---|
| i-1 | —CH₃ | —CH₃ | —C₂H₅ |
| i-2 | —C₂H₅ | —CH₃ | —C₂H₅ |
| i-3 | —CH(CH₃)₂ | —CH₃ | —C₂H₅ |
| i-4 | —C(CH₃)₃ | —CH₃ | —C₂H₅ |
| i-5 | 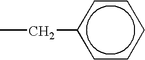 | —CH₃ | —C₂H₅ |
| i-6 | 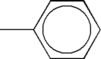 | —CH₃ | —C₂H₅ |
| i-7 | —CH₂OCH₃ | —CH₃ | —C₂H₅ |
| i-8 | —CH₂Cl | —CH₃ | —C₂H₅ |
| i-9 | —CCl₃ | —CH₃ | —C₂H₅ |
| i-10 | —CF₃ | —CH₃ | —C₂H₅ |
| i-11 | 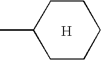 | —CH₃ | —C₂H₅ |
| i-12 | 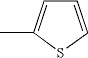 | —CH₃ | —C₂H₅ |
| i-13 | —C₃H₇(n) | —CH₃ | —C₂H₅ |
| i-14 | —CH₃ | —CH₃ | —C₄H₉(n) |
| i-15 | —CH₃ | —CH₃ | —C₈H₁₇(n) |
| i-16 | —CH(CH₃)₂ | —CH₃ | —C₄H₅(n) |
| i-17 | 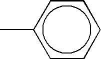 | —CH₃ | —C₅H₁₁(n) |
| i-18 | —CH₂OCH₃ | —CH₃ | —C₈H₁₇(n) |
| i-19 | —CH₃ | —CH₃ | 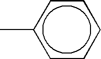 |
| i-20 | 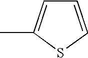 | —CH₃ | —C₆H₁₃(n) |
| i-21 | —CH₃ | 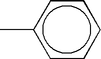 | —C₂H₅ |
| i-22 | —CH₃ | 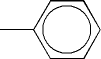 | —C₈H₁₇(n) |
| ia-1 | —C₅H₁₁(n) | —CH₃ | —C₂H₅ |
| ia-2 | —C₇H₁₅(n) | —CH₃ | —C₂H₅ |
| ia-3 | —C₁₇H₃₅(n) | —CH₃ | —C₂H₅ |
| ia-4 | 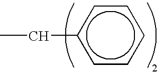 | —CH₃ | —C₂H₅ |
| ia-5 | 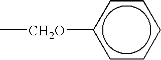 | —CH₃ | —C₂H₅ |
| ia-6 | 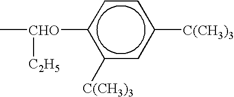 | —Ch₃ | —C₂H₅ |
| ia-7 | —CH₃ | —CH₃ | —C₅H₁₁(n) |
| ia-8 | —CH₃ | —CH₃ | —CH(CH₃)₂ |
| ia-9 | —C₃H₇(n) | —CH₃ | —C₈H₁₇(n) |
| ia-10 | —C₄H₉(n) | —CH₃ | —C₈H₁₇(n) |
| ia-11 | —CH(CH₃)₂ | —CH₃ | —C₈H₁₇(n) |
| ia-12 | —C₃H₇(t) | —CH₃ | —C₈H₁₇(n) |
| ia-13 | —C₄H₉(t) | —CH₃ | —C₈H₁₇(n) |
| ia-14 | 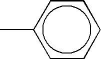 | —CH₃ | —C₈H₁₇(n) |
| ia-15 | 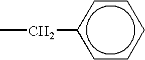 | —CH₃ | —C₈H₁₇(n) |
| ia-16 | 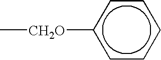 | —CH₃ | —C₈H₁₇(n) |
| ia-17 | —C₃H₇(n) | —CH₃ | 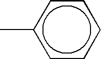 |
| ia-18 | —CH₃ | —CH₃ | 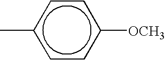 |

| | |
|---|---|
| i-23 | 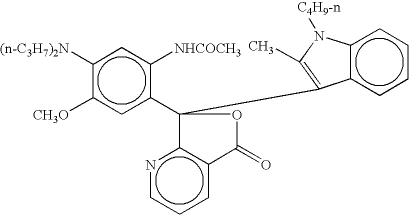 |
| i-24 | 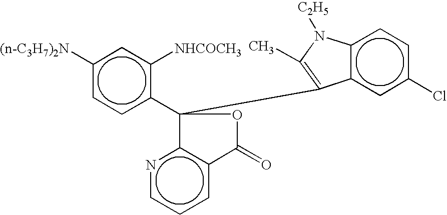 |
| i-25 | 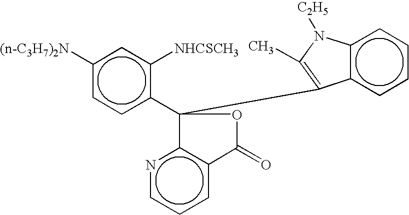 |
| i-26 | 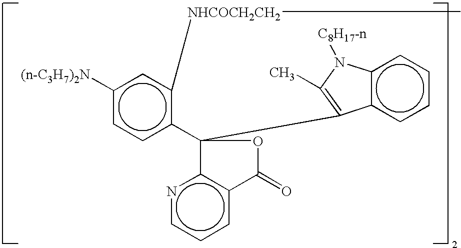 |

(Specific Examples of Electron-Accepting Compound)

Examples of the electron-accepting compound include phenol derivatives, salicylic acid derivatives and hydroxybenzoic acid esters. In particular, bisphenols and hydroxybenzoic acid esters are preferably used. Representative examples thereof include: 2,2-bis(p-hydroxyphenyl)propane (i.e., bisphenol A), 4,4′-(p-phenylene diisopropylidene)diphenol (i.e., bisphenol P), 2,2-bis(p-hydroxyphenyl)pentane, 2,2-bis(p-hydroxyphenyl)ethane, 2,2-bis(p-hydroxyphenyl)butane, 2,2-bis(4′-hydroxy-3′,5′-dichlorophenyl)propane, 1,1-(p-hydroxyphenyl)cyclohexane, 1,1-(p-hydroxyphenyl)propane, 1,1-(p-hydroxyphenyl)pentane, 1,1-(p-hydroxyphenyl)-2-ethylhexane, 3,5-di(α-methylbenzyl)salicylic acid and polyhydric metal salts thereof, 3,5-di(tert-butyl)salicylic acid and polyhydric metal salts thereof, 3-α,α-dimethylbenzylsalicylic acid and polyhydric metal salts thereof, butyl p-hydroxybenzoate, benzyl p-hydroxybenzoate, 2-ethylhexyl p-hydroxybenzoate, p-phenylphenol, and p-cumylphenol.

(Microcapsules)

In the invention, the manner to use the above-described diazonium salt compound, the coupler capable of reacting with the diazonium salt compound upon application of heat to develop color, the basic substance, the electron-donating colorless dye, the electron-accepting compound, and additionally, a sensitizer or the like are not particularly limited, and there may be employed the following methods: (1) a method in which these ingredients are used as a solid dispersion, (2) a method in which these ingredients are emulsifying-dispersed and used, (3) a method in which these ingredients are polymer-dispersed and used, (4) a method in which these ingredients are latex-dispersed and used, and (5) a method in which these ingredients are formed into microcapsules and used. Among these methods, from the viewpoint of storability, the method in which these ingredients are formed into microcapsules and used is preferably adopted. In particular, in the case of the color-developing system utilizing the reaction between a diazonium salt compound and a coupler, the diazonium salt compound is preferably formed into microcapsules. Also in the case of the color-developing system utilizing the reaction between an electron-donating colorless dye and an electron-accepting compound, the electron-donating colorless dye is preferably formed into microcapsules.

As the method for forming the microcapsules, conventionally known methods may be employed. It is necessary for the polymer substance for forming the microcapsule wall to exhibit non-permeability at normal temperature, but to exert permeability upon application of heat. In particular, the polymer substances having a glass transition temperature ranging from 60 to 200° C. are preferably used. Examples thereof include polyurethane, polyurea, polyamide, polyester, urea-formaldehyde resin, melamine resin, polystyrene, styrene/methacrylate copolymer, styrene/acrylate copolymer and mixtures thereof.

In order to form the microcapsules, interfacial polymerization and an internal polymerization are preferably employed, and specific examples thereof and relevant reactants are described, for example, in specifications of U.S. Pat. Nos. 3,726,804 and 3,796,669. For example, in case where polyurea or polyurethane is used as the capsule wall material, polyisocyanate and a second substance capable of reacting with polyisocyanate to form the capsule wall (e.g., polyol, polyamine) are admixed in an aqueous vehicle or an oil vehicle to be encapsulated, and these are emulsion-dispersed in water, and then heated to effect a polymer-forming reaction at the interface of oil droplets to thus form the microcapsule wall. Incidentally, even if the addition of the above-mentioned second substance is omitted, polyurea may be produced.

In the present invention, it is preferable that the polymer substance for forming the microcapsule wall is at least one selected from the group consisting of polyurethane and polyurea.

Taking as an example microcapsules that contain the diazonium salt compound (with a wall of polyurea, polyurethane), a method for producing the microcapsules is set forth below.

First, a diazonium salt compound is dissolved or dispersed in a high-boiling-point solvent to prepare an oil phase that forms a core of the microcapsule. In the invention, the high-boiling-point solvent is preferably used at a proportion of 0.25 to 10 parts by mass, and more preferably 0.5 to 5 parts by mass, relative to 1 part by mass of the diazonium salt compound. The content of less than 0.25 parts by mass may increase background fogging, and the content exceeding 10 parts by mass may cause difficulties in obtaining sufficient color-developing density. When preparing this oil phase, polyhydric isocyanate is added thereto as a material for forming the capsule wall.

Examples of the high-boiling-point solvent include alkyl biphenyl, alkyl naphthalene, alkyl diphenyl ethane, alkyl diphenyl methane, chlorinated paraffin, tricresyl phosphate, maleic acid esters, adipic acid esters and phthalic acid esters, and these may be used in combination of two or more thereof.

When preparing the oil phase, the diazonium salt compound is usually dissolved in a core oil, however, in case where the diazonium salt compound has poor solubility in the high-boiling-point solvent, a low-boiling-point solvent (boiling point: lower than 100° C.) having a higher solubility therein may be used in combination as an auxiliary solvent. Examples of the low-boiling-point solvent include ethyl acetate, butyl acetate, methylene chloride, tetrahydrofuran and acetone. In this case, the low-boiling-point solvent is evaporated off during the encapsulating reaction, whereby the solvent does not remain in the produced capsules. Hence, the use amount thereof is not particularly limited.

Therefore, it is preferable that the diazonium salt compound has an appropriate solubility in the above-mentioned low-boiling-point solvent and high-boiling-point solvent. More specifically, the diazonium salt compound preferably has a solubility in the solvent of greater than 5% and a solubility in water of less than 1%.

On the other hand, for use as the aqueous phase, an aqueous solution in which a water-soluble polymer has been dissolved is employed, and after the above-mentioned oil phase has been poured into this aqueous phase, an emulsifying and dispersing operation is carried out using a homogenizer or the like. In this case, the above-mentioned water-soluble polymer contributes to readily carry out the homogeneously dispersing operation, and also acts as a dispersant to stabilize the resultant aqueous solution that has undergone the emulsion-dispersing operation. In order to conduct the operation to obtain a uniform and stable emulsified dispersion, a surfactant may be added to at least either the oil phase or the aqueous phase. Conventionally known emulsion-use surfactants may be used. When the surfactant is added, the addition amount of the surfactant preferably ranges from 0.1% to 5%, and more preferably from 0.5 to 2%, relative to the mass of the oil phase.

As the water-soluble polymer added to the above-mentioned aqueous solution during the emulsifying and dispersing operation, a water-soluble polymer having a solubility in water of greater than 5 at a temperature performing the emulsifying process. Specific examples thereof include: polyvinyl alcohol and its modified substances, polyacrylic acid amides and derivatives thereof, ethylene/vinyl acetate copolymer, styrene/maleic anhydride copolymer, ethylene/maleic anhydride copolymer, isobutylene/maleic anhydride copolymer, polyvinyl pyrrolidone, ethylene/acrylic acid copolymer, vinyl acetate/acrylic acid copolymer, carboxymethyl cellulose, methyl cellulose, casein, gelatin, starch derivatives, Arabic rubber and sodium alginate.

It is preferable for these water-soluble polymers to exhibit no reactivity or low reactivity to the isocyanate compound added as a wall material. In case of the polymer having a reactive amino group in a molecular chain, such as gelatin, it is necessary to eliminate its reactivity by preliminarily subjecting the polymer to a modifying treatment.

As the polyhydric isocyanate compound, the isocyanate compound having tri- or higher functional groups is preferably used, optionally in combination with a di-functional isocyanate compound. Specifically, xylene diisocyanate and hydrogenated products thereof, or hexamethylene diisocyanate, tolylenediisocyanate and hydrogenated products thereof, or the dimers or trimers (biuret or isocyanurate) having diisocyanate as a main unit, such as isophoronediisocyanate, and polyfunctional products formed as an adduct with a polyol, such as trimethylol propane, and a formalin condensate of benzeneisocyanate are preferable.

The use amount of the polyhydric isocyanate is specified to achieve the average particle size of the microcapsules of from 0.3 to 12 μm and a wall thickness of from 0.01 to 0.3 μm. Usually, the size of particles dispersed ranges from about 0.2 to 10 μm. The polymerizing reaction of polyhydric isocyanate takes place at the interface between the oil phase and the aqueous phase during the emulsifying and dispersing operation, thereby forming the polyurea wall.

Moreover, if polyol or polyamine is preliminarily added to the aqueous phase or a hydrophobic solvent, a reaction occurs with polyhydric isocyanate to form a material for constructing the microcapsule wall. It is preferable to proceed this reaction with maintaining an elevated temperature or by adding an appropriate polymerization catalyst thereto, in order to accelerate the reaction rate.

Specific examples of these polyols or polyamines include: propylene glycol, glycerin, trimethylolpropane, triethanolamine, sorbitol and hexamethylenediamine. In case where polyol is used, the polyurethane wall is formed.

Polyhydric isocyanate, polyol, a reaction catalyst, polyamine and the like for forming the capsule wall are detailed in a book (see, Polyurethane Handbook, edited by Keiji IWATA, published by The Nikkan Kogyo Shimbun, Ltd. (1987)).

The emulsifying operation may be carried out using a known emulsifier such as a homogenizer, Manton Gaulin, ultrasonic disperser, Dissolver and KD mill. After the emulsifying operation is complete, the emulsified matters are heated to 30 to 70° C. so as to facilitate the capsule-wall-forming reaction. During the reaction, it is also necessary to add water so as to reduce colliding probability of the capsules, or to provide sufficient stirring so as to prevent capsules from flocculating with one another.

It is also preferable to further add an antiflocculating dispersant during the reaction. As the polymerizing reaction progresses, carbon dioxide is observed to generate and the end of the generation is regarded as the termination of the capsule-wall forming reaction. Normally, the reaction duration for several hours makes it possible to obtain microcapsules containing a desired diazonium salt.

(Layer Construction of Heat-Sensitive Recording Material)

The heat-sensitive recording material of the invention comprises a laminated heat-sensitive recording multilayer. And by changing the hues of the respective photofixation-type heat-sensitive recording layers, it is possible to obtain multi-color heat-sensitive recording materials. Although not particularly limited, multi-color heat-sensitive recording materials have a layer construction, in which two photofixation-type heat-sensitive recording layers each containing different kinds of diazonium salt compounds having mutually different photosensitive wavelengths and respective couplers that react with the respective diazonium salt compounds upon application of heat to develop colors of different hues and one photofixation-type heat-sensitive recording layer containing an electron-donating colorless dye in combination with an electron-accepting compound are arranged. In other words, the material comprises a support having disposed thereon a first photofixation-type heat-sensitive recording layer containing the electron-donating colorless dye and the electron-accepting compound, a second photofixation-type heat-sensitive recording layer containing a diazonium salt compound having a maximum absorption wavelength of 365±40 nm and a coupler capable of reacting with the diazonium salt compound upon application of heat to develop color, and a third photofixation-type heat-sensitive recording layer containing another diazonium salt compound having a maximum absorption wavelength of 425±40 nm and another coupler capable of reacting with the another diazonium salt compound upon application of heat to develop color. In such a layer construction, if the color-developing hues of the respective photofixation-type heat-sensitive recording layers are selected to form three primary colors for subtractive color mixing, i.e., yellow, magenta and cyan, full-color image recording processes can be achieved.

In the recording method using this multi-color heat-sensitive recording material, first, the third photofixation-type heat-sensitive recording layer is heated to allow the diazonium salt compound to react with the coupler, both contained in this layer, to develop a color. Then, after the unreacted diazonium salt compound present in the third photofixation-type heat-sensitive recording layer has been decomposed by irradiating the material with light having a wavelength of 425±40 nm, sufficient heat is applied to make the second photofixation-type heat-sensitive recording layer to develop a color, whereby the another diazonium salt compound and the another coupler, both contained in this layer, are allowed to develop a color. At this time, although the third photofixation-type heat-sensitive recording layer is also strongly heated simultaneously, the diazonium salt compound present therein has already been decomposed and is no longer capable of developing a color, whereby no color is developed any more. Further, by irradiating the material with light having a wavelength of 365±40 nm, the another diazonium salt compound contained in the second photofixation-type heat-sensitive recording layer is decomposed, and finally, sufficient heat is applied to allow the first photofixation-type heat-sensitive recording layer to develop a color. At this moment, although the third and the second photofixation-type heat-sensitive recording layers are also strongly heated simultaneously, the diazonium salt compounds contained therein have already been decomposed and are no longer capable of developing a color, whereby no color is developed any more.

In the present invention, in order to improve light-fastness, there may be used conventionally known antioxidants described in the patent publications, for example, European Patent Application Laid-Open No. 310551, German Patent Application Laid-Open No. 3435443, EP Laid-Open No. 310552, JP-A No. 3-121449, EP Laid-Open No. 459416, JP-A Nos. 2-262654, 2-71262, 63-163351, U.S. Pat. No. 4,814,262, JP-A Nos. 54-48535, 5-61166, 5-119449, U.S. Pat. No. 4,980,275, JP-A Nos. 63-113536, 62-262047, EP Laid-Open Nos. 223739, 309402 and 309401.

In addition, a variety of conventionally known additives for use in the heat-sensitive recording material and the pressure-sensitive recording material may be used effectively. Some of these antioxidants are, for example, compounds disclosed in the following patent publications: JP-A Nos. 60-125470, 60-125471, 60-125472, 60-287485, 60-287486, 60-287487, 62-146680, 60-287488, 62-282885, 63-89877, 63-88380, 63-088381, 01-239282, 04-291685, 04-291684, 05-188687, 05-188686, 05-110490, 05-1108437, 05-170361, 63-203372, 63-224989, 63-267594, 63-182484, 60-107384, 60-107383, 61-160287, 61-185483, 61-211079, 63-251282, 63-051174, JP-B Nos. 48-043294 and 48-033212.

As the binder for use in the photosensitive recording layer, conventionally known ones may be used, and examples thereof include water-soluble polymers such as polyvinyl alcohol and gelatin, and polymer latex.

Light-Transmittance Adjusting Layer

In the heat-sensitive recording material of the invention, a light-transmittance adjusting layer is preferably provided in order to improve light-fastness.

The light-transmittance adjusting layer contains a UV absorbent precursor, and exhibits a high light transmittance since the precursor does not function as a UV absorbent prior to light irradiation, and allows transmission of light having wavelengths in a range required for photofixation. This adjusting layer, due to a high light transmittance with respect to visible light, does not find difficulty in performing photofixation of the heat-sensitive recording layer. It is preferably devised for the UV absorbent precursor to be contained in the microcapsules.

The compounds to be contained in the light-transmittance adjusting layer are described, for example, in JP-A No. 9-1928.

Upon completion of irradiating the heat-sensitive recording layer with light having wavelengths in a range required for photofixation, the above-described UV absorbent precursor acquires a function as the UV absorbent upon effecting a reaction caused by light or heat, whereby most of light rays having wavelengths in a range required for photofixation in a UV region are absorbed by the UV absorbent. As a result, the light transmittance becomes lowered while increasing light-fastness of the heat-sensitive recording material; however, since the absorbent does not have the effect of absorbing visible light rays, there is virtually no change in transmittance with respect to visible light rays.

The heat-sensitive recording material may comprise at least one light-transmittance adjusting layer, and most preferably, this layer is formed between the heat-sensitive recording layer and an outermost protective layer. The light-transmittance adjusting layer may be devised to also serve as the protective layer. The characteristics of the light-transmittance adjusting layer may be desirably selected in accordance with the characteristics of the heat-sensitive recording layer.

A coating solution for forming the light-transmittance adjusting layer may be prepared by mixing the above-described ingredients. The coating solution for the light-transmittance adjusting layer is applied using conventionally known coating methods, such as a bar coater, an air knife coater, a blade coater and a curtain coater. The coating solution for the light-transmittance adjusting layer may be applied simultaneously with the coating solution for the heat-sensitive recording layer. For example, the coating solution for forming the heat-sensitive recording layer is applied, and after the heat-sensitive recording layer has been dried, the coating solution for the light-transmittance adjusting layer may be applied so as to be disposed on the formed recording layer.

The coated amount of the light-transmittance adjusting layer after dried preferably ranges from 0.8 to 4.0 g/m².

Protective Layer

In the heat-sensitive recording material of the invention, a protective layer may optionally be disposed on the surface of the heat-sensitive recording layer; and two or more protective layers may be provided, if necessary. Examples of the binder preferably for use in the above-described protective layer include: modified polyvinyl alcohol (silanol-modified polyvinyl alcohol, long-chain alkylether-modified polyvinyl alcohol, acetoacetyl-modified polyvinyl alcohol, carboxy-modified polyvinyl alcohol, etc.), polyvinyl alcohol silicone-modified polymer, carboxymethyl cellulose and hydroxyethyl cellulose, and these may be used singly or in combination of two or more kinds thereof.

The above-mentioned protective layer preferably contains a pigment. As the pigment, inorganic ultrafine particles are preferably used; and examples of the inorganic ultrafine particles include: colloidal silica, zirconia oxide, barium sulfate, aluminum oxide (alumina), zinc oxide, magnesium oxide, calcium oxide, cerium oxide and titanium oxide; and these may be used singly or in combination of two or more kinds thereof.

More preferably, the protective layer is formed by applying a coating solution for the protective layer containing silanol-modified polyvinyl alcohol and colloidal silica onto a heat-sensitive recording layer using a device such as a bar coater, an air knife coater, a blade coater and a curtain coater, followed by drying. The coating solution for the protective layer may be applied by simultaneously applying the coating solutions for the heat-sensitive recording layer, etc., through a simultaneous multilayer coating method, or may be formed by employing processes in which, after application of the coating solution for the heat-sensitive recording layer, etc., followed by drying, the coating solution for the protective layer may be applied thereon. The coating amount of the solids component of the protective layer preferably ranges from 0.1 to 3 g/m², and more preferably from 0.3 to 2.0 g/m². If this coating amount is too large, heat sensitivity is seriously lowered, while, if this coating amount is too small, the layer fails to properly exert its function as the protective layer (abrasion resistance, lubricating property, anti-scratching property, etc.). Further, after its application, the protective layer may be subjected to a calendering treatment, if necessary.

Support

As the support, usable examples include: polyethylene terephthalate (PET), polyethylene naphthalate (PEN), triacetyl cellulose (TAC), paper, plastic resin-laminated paper and synthetic paper. Moreover, in order to obtain transparent heat-sensitive recording material, it is necessary to use a transparent support. Examples of the transparent support include synthetic polymer films such as polyester film, e.g., polyethylene terephthalate and polybutylene terephthalate, cellulose triacetate film, and polyolefin films, e.g., polypropylene and polyethylene.

The support may be used alone or by adhering two or more kinds thereof.

The thickness of the above-described synthetic polymer film preferably ranges from 25 to 300 μm, and more preferably from 100 to 250 μm.

The above-described synthetic polymer film may be colored with a desired hue. As the method for coloring the polymer film, the following methods may be employed: a method in which a dye is preliminarily added to a resin prior to the formation of a film, then kneaded and molded into a film shape; and a method in which a coating solution is prepared by dissolving a dye in an appropriate solvent and the resultant mixture is applied onto a transparent colorless resin film using a known method, such as a gravure coating method, roller coating method and wire coating method, and then dried. Among these, a method in which a blue dye is added to polyester resin such as polyethylene terephthalate or polyethylene naphthalate, then kneaded and molded into a film shape, and subjected to heat resistance treatment, stretching treatment and antistatic treatment, is preferably employed.

The above-described heat-sensitive recording layer, protective layer, light-transmittance adjusting layer, intermediate layer, etc., may be formed on a support by applying the respective coating solutions using a known coating method, such as a blade coating method, an air knife coating method, a gravure coating method, a roll coating method, a spray coating method, a dip coating method and a bar coating method, and then dried.

### EXAMPLES

The heat-sensitive recording material of the present invention will now be illustrated by the following Examples, but it is to be understood that the invention is not limited to the Examples. In the Examples, “part(s)” and “%” are all by mass, unless otherwise indicated.

### Example 1

<Preparation of Phthalated Gelatin Solution>

32 parts of phthalated gelatin (trade name; MGP gelatin, manufactured by Nippi Collagen Co., Ltd.), 0.9143 part of 1,2-benzothiazoline-3-one (3.5% methanol solution, manufactured by Daito Chemical Industries, Ltd.) and 367.1 parts of ion exchange water were mixed and dissolved at 40° C. to prepare an aqueous phthalated gelatin solution.

<Preparation of Alkali-Treated Gelatin Solution>

25.5 parts of alkali-treated low-ionic gelatin (trade name; #750 gelatin, manufactured by Nitta Gelatin Inc.), 0.7286 part of 1,2-benzothiazoline-3-one (3.5% methanol solution, manufactured by Daito Chemical Industries, Ltd.), 0.153 part of calcium hydroxide and 143.6 parts of ion exchange water were mixed and dissolved at 50° C. to prepare an aqueous alkali-treated gelatin solution for forming an emulsion.

Preparation of a Yellow Heat-Sensitive Recording Layer Solution

<Preparation of Microcapsule Solution (a) Containing Diazonium Salt Compound>

To 16.1 parts of ethyl acetate were added 2.2 parts of the following diazonium compound (A)(maximum absorption wavelength 420 nm), 2.2 parts of the following diazonium compound (B) (maximum absorption wavelength 420 nm), 7.2 parts of monoisopropyl biphenyl, 2.4 parts of diphenyl phthalate and 0.4 part of diphenyl-(2,4,6-trimethylbenzoyl) phosphine oxide (trade name; Lucirin TPO, manufactured by BASF Japan K.K.) and heated to 40° C. to produce a uniform mixed solution. To this mixed solution was added 8.6 parts of a mixture of xylylene diisocyanate/trimethylolpropane adduct and xylylene diisocyanate/bisphenol A adduct (trade name; Takenate D119N (50% ethyl acetate solution), manufactured by Takeda Chemical Industries, Ltd.) as a capsule wall material, and homogeneously stirred to obtain a mixed solution (I).

Separately, to 58.6 parts of the above-mentioned phthalated gelatin solution were added 16.3 parts of ion exchange water and 0.34 part of Scraph AG-8 (50%; manufactured by Nippon Fine Chemical Co., Ltd.) to obtain a mixed solution (II).

Mixed solution (I) was added to mixed solution (II), and the resultant mixture was emulsified and dispersed at 40° C. using a homogenizer (Nihon Seiki Seisakusho K.K.). To the resulting emulsion was added 20 parts of water and thoroughly mixed, after which a capsulating reaction was effected to proceed for 3 hours with stirring at 40° C. while removing ethyl acetate. Thereafter, to this were added 4.1 parts of ion-exchange resin Amberlite IRA68 (manufactured by Organo Corporation) and 8.2 parts of Amberlite IRC50 (manufactured by Organo Corporation), and then stirred for additional one hour. Then, the resultant product was filtrated to remove the ion exchange resin and the solids concentration of the capsule solution was adjusted to 20.0%, to thus obtain a solution containing microcapsules (a) in which the diazonium salt compound was encapsulated. The particle size of the produced microcapsules was measured (by LA-700, manufactured by Horiba Ltd.) and the median diameter was found to be 0.36 μm.

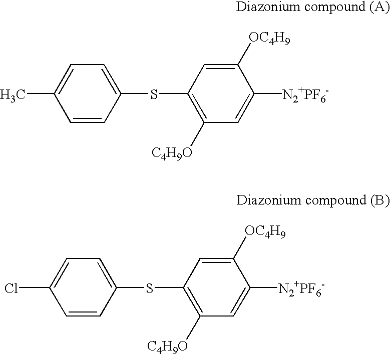

<Preparation of Coupler Compound Emulsion (a)>

To 33.0 parts of ethyl acetate were added 9.9 parts of the following coupler compound (C), 13.9 parts of triphenyl guanidine (manufactured by Hodogaya Chemical Co., Ltd.), 16.8 parts of 4,4′-(m-phenylene diisopropylidene)diphenol (trade name; bisphenol M, manufactured by Mitsui Petrochemical Industries, Ltd.), 3.3 parts of 3,3,3′,3′-tetramethyl-5,5′,6,6′-tetra(1-propyloxy)-1,1′-spirobisindane, 13.6 parts of 4-(2-ethylhexyloxy)benzenesulfonic acid amide (Manac Incorporated), 6.8 parts of 4-n-pentyloxy benzenesulfonic acid amide (Manac Incorporated) and 4.2 parts of calcium dodecylbenzenesulfonate (trade name: Pionin A-41-C, 70% methanol solution; manufactured by Takemoto Oil & Fat Co., Ltd.) and dissolved to obtain a mixed solution (III).

Separately, to 206.3 parts of the above-produced alkali-treated gelatin solution was added 107.3 parts of ion exchange water to obtain a mixed solution (IV).

Mixed solution (III) was added to mixed solution (IV), and the resultant mixture was emulsified and dispersed at 40° C. using a homogenizer (manufactured by Nihon Seiki Seisakusho K.K.). The obtained coupler compound emulsified matter was heated under reduced pressure to remove ethyl acetate, and the solids concentration was adjusted to 26.5%. The particle size of the resulting coupler compound emulsified matter was measured (by LA-700, manufactured by Horiba Ltd.) and the median diameter was found to be 0.21 μm.

Further, to 100 parts of the above-produced coupler compound emulsified matter was added 9 parts of SBR latex (trade name; SN-307, 48% solution, manufactured by Sumika ABS Latex K.K.) whose concentration had been adjusted to 26.5%, and homogeneously stirred to obtain a coupler compound emulsion (a).

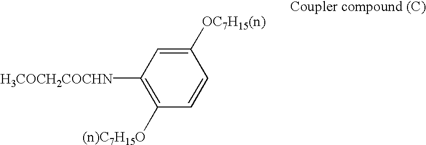

<Preparation of Coating Solution (a)>

The above-produced solution containing microcapsules (a) in which the diazonium salt compound had been encapsulated was mixed with the above-prepared coupler compound emulsion (a) to give a mass ratio of the encapsulated coupler compound/diazonium salt compound of 2.2/1, to thus obtain a coating solution (a) for the heat-sensitive recording layer, which was used for the coating solution for a yellow heat-sensitive recording layer.

Preparation of a Magenta Heat-Sensitive Recording Layer Solution

<Preparation of Microcapsule Solution (b) Containing Diazonium Salt Compound>

To 15.1 parts of ethyl acetate were added 2.8 parts of the following diazonium compound (D)(maximum absorption wavelength 365 nm), 3.0 parts of diphenyl phthalate, 4.7 parts of phenyl 2-benzoyloxybenzoate, 4.2 parts of the following ester compound (trade name; LIGHT-ESTER TMP, manufactured by Kyoe Yushi Chemical Co., Ltd.) and 0.1 part of calcium dodecylbenzenesulfonate (trade name; Pionin A-41-C, 70% methanol solution, manufactured by Takemoto Oil & Fat Co., Ltd.) and heated to form a uniform mixed solution. To this mixed solution was added 2.5 parts of a mixture of xylylene diisocyanate/trimethylol propane adduct and xylylene diisocyanate/bisphenol A adduct (trade name; Takenate D119N (50% ethyl acetate solution) manufactured by Takeda Chemical Industries, Ltd.) and 6.8 parts of xylylene diisocyanate/trimethylolpropane adduct (trade name; Takenate D110N (75% ethyl acetate solution) manufactured by Takeda Chemical Industries, Ltd.) as a capsule material, and homogeneously stirred to obtain a mixed solution (V).

Separately, to 55.3 parts of the above-mentioned phthalated gelatin solution was added 21.0 parts of ion exchange water to obtain a mixed solution (VI).

Mixed solution (V) was added to mixed solution (VI), and the resultant mixture was emulsified and dispersed at 40° C. using a homogenizer (Nihon Seiki Seisakusho K.K.). To the resulting emulsion was added 24 parts of water and thoroughly mixed, after which an encapsulating reaction was effected to progress for 3 hours with stirring at 40° C. while removing ethyl acetate. Thereafter, to this were added 4.1 parts of ion-exchange resin Amberlite IRA68 (manufactured by Organo Corporation) and 8.2 parts of Amberlite IRC50 (manufactured by Organo Corporation), and stirred for another one hour. Then, the resultant product was filtrated to remove the ion exchange resin and the solids concentration of the capsule solution was adjusted to 20.0%, to thereby obtain a solution containing microcapsules (b) in which the diazonium salt compound was encapsulated. The particle size of the produced microcapsules was measured (by LA-700, manufactured by Horiba Ltd.) and the median diameter was found to be 0.43 μm.

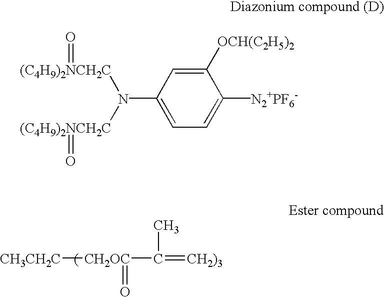

<Preparation of Coupler Compound Emulsion (b)>

To 36.9 parts of ethyl acetate were added 11.9 parts of the following coupler compound (E), 10.0 parts of triphenyl guanidine (manufactured by Hodogaya Chemical Co., Ltd.), 18.0 parts of 4,4′-(m-phenylene diisopropylidene)diphenol (trade name; bisphenol M (manufactured by Mitsui Petrochemical Industries, Ltd.), 14 parts of 1,1-(p-hydroxyphenyl)-2-ethylhexane, 3.5 parts of 3,3,3′,3′-tetramethyl-5,5′,6,6′-tetra(1-propyloxy)-1,1′-spirobisindane, 3.5 parts of the following compound (G), 1.7 parts of tricresyl phosphate, 0.8 part of diethyl maleate and 4.5 parts of calcium dodecylbenzenesulfonate (trade name: Pionin A-41-C, 70% methanol solution; manufactured by Takemoto Oil & Fat Co., Ltd.) and dissolved to obtain a mixed solution (VII).

Separately, to 206.3 parts of an aqueous alkali-treated gelatin solution was added 107.3 parts of ion exchange water to obtain a mixed solution (VIII).

Mixed solution (VII) was added to mixed solution (VIII), and the resultant mixture was emulsified and dispersed at 40° C. using a homogenizer (Nihon Seiki Seisakusho K.K.). The obtained coupler compound emulsified matter was heated under reduced pressure to remove ethyl acetate, and the solids concentration was adjusted to 24.5%, to thereby obtain a coupler compound emulsion (b). The particle size of the resulting coupler compound emulsion was measured (by LA-700, manufactured by Horiba Ltd.) and the median diameter was found to be

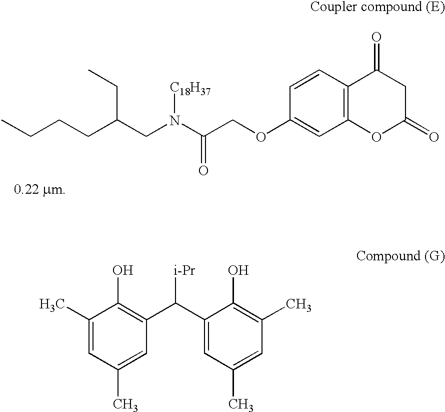

<Preparation of Coating Solution (b)>

The above-produced solution containing microcapsules (b) in which the diazonium salt compound had been encapsulated was mixed with the above-mentioned coupler compound emulsion (b) such that the mass ratio of the encapsulated coupler compound/diazonium salt compound was made 3.5/1. Further, an aqueous solution (5%) of polystyrenesulfonic acid (partially neutralized by potassium hydroxide) was admixed therewith in a proportion of 0.2 parts relative to 10 parts of the capsule solution, to thus obtain a coating solution (b) for the heat-sensitive recording layer, which was used for the coating solution for a magenta heat-sensitive recording layer.

Preparation of a Cyan Heat-Sensitive Recording Layer Solution

<Preparation of Microcapsule Solution (c) Containing Electron-Donating Dye Precursor>

To 18.1 parts of ethyl acetate were added 7.6 parts of the following electron-donating dye (H), 8.0 parts of a mixture of 1-methylpropylphenyl-phenylmethane and 1-(1-methylpropylphenyl)-2-phenylethane (trade name; Hizole SAS-310, manufactured by Nippon Oil Company Ltd.) and 10.0 parts of the following compound (I) (trade name; Irgaperm 2140, manufactured by Ciba-Geigy Corp.) and heated to prepare a uniform mixed solution. To this mixed solution were added 7.2 parts of xylylene diisocyanate/trimethylolpropane adduct (trade name; Takenate D110N (75% ethyl acetate solution) manufactured by Takeda Chemical Industries, Ltd.) and 5.3 parts of polymethylene polyphenyl polyisocyanate (trade name; Millionate MR-200, manufactured by Nippon Polyurethane Industry Co., Ltd.), and homogeneously stirred to obtain a mixed solution (IX).

Separately, to 28.8 parts of the above-mentioned aqueous phthalated gelatin solution were added 9.5 parts of ion exchange water and 0.17 parts of Seraph AG-8 (50%; manufactured by Nippon Fine Chemical Co., Ltd.) and 4.3 parts of sodium dodecylbenzenesulfonate (10% aqueous solution) to obtain a mixed solution (X).

Mixed solution (IX) was added to mixed solution (X), and the resultant mixture was emulsified and dispersed at 40° C. using a homogenizer (Nihon Seiki Seisakusho K.K.). To the resulting emulsion were added 50 parts of water and 0.12 part of tetraethylenepentamine and thoroughly mixed, and an encapsulating reaction was effected to proceed for 3 hours with stirring at 65° C. while removing ethyl acetate, after which the solids concentration of the capsule solution was adjusted to 33%, to thus obtain a microcapsule solution. The particle size of the produced microcapsules was measured (by LA-700, manufactured by Horiba Ltd.) and the median diameter was found to be 1.00 μm.

To 100 parts of the above-produced microcapsule solution were added 3.7 parts of a 25% aqueous solution of sodium dodecyl-benzenesulfonate (trade name; NEOPELEX F-25, manufactured by Kao Corporation) and 4.2 parts of a fluorescent brightener containing 4,4′-bistriazinyl aminostilbene-2,2′-disulfone derivative (trade name; Kaycoll BXNL, manufactured by Nippon Soda Co., Ltd.) and homogeneously stirred, to obtain a microcapsule dispersion (c).

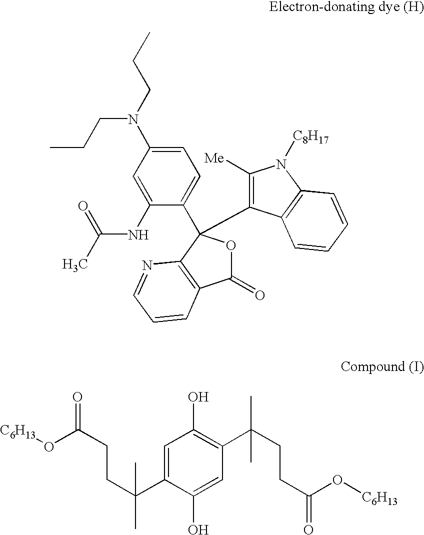

<Preparation of Electron-Accepting Compound Dispersion (c)>

To 11.3 parts of the above-produced aqueous phthalated gelatin solution were added 30.1 parts of ion exchange water, 15 parts of 4,4′-(p-phenylene diisopropylidene)diphenol (trade name; bisphenol P, manufactured by Mitsui Petrochemical Industries, Ltd.) and 3.8 parts of a 2% aqueous solution of sodium 2-ethylhexyl succinate, and the resultant mixture was subjected to dispersing operation overnight using a ball mill to produce a dispersion. The solids concentration of this dispersion was 26.6%.

To 100 parts of the above-obtained dispersion was added 45.2 parts of the above-mentioned aqueous alkali-treated gelatin solution, and after homogeneously stirred for 30 minutes, to which was added ion exchange water so as to make the solids concentration of the dispersion to reach 23.5%, thus yielding an electron-accepting compound dispersion (c).

<Preparation of Coating Solution (c)>

The microcapsule solution (c) which included the encapsulated electron-donating dye precursor was mixed with the electron-accepting compound dispersion (c) to give a mass ratio of the electron-accepting compound/electron-donating dye precursor of 10/1, thus obtaining a coating solution (c) for the heat-sensitive recording layer, which was used for the coating solution for a cyan heat-sensitive recording layer.

Preparation of an Aqueous Gelatin Solution for Forming an Intermediate Layer

100.0 parts of alkali-treated low-ionic gelatin (trade name; #750 gelatin, manufactured by Nitta Gelatin K.K.), 2.857 parts of 1,2-benzothiazoline-3-one (3.5% methanol solution, manufactured by Daito Chemical Industries, Ltd.), 0.5 parts of calcium hydroxide and 521.643 parts of ion exchange water were mixed and dissolved at 50° C. to thereby prepare an aqueous gelatin solution for forming the intermediate layer.

Preparation of a Coating Solution (a) for Forming an Intermediate Layer

10.0 parts of the aqueous gelatin solution for forming the intermediate layer, 0.05 part of sodium(4-nonylphenoxytrioxyethylene) butylsulfonate (manufactured by Sankyo Chemical Industries, Ltd., 2.0% aqueous solution), 2.07 parts of boric acid (4.0% aqueous solution), 0.19 part of an aqueous solution (5%) of polystyrenesulfonic acid (partially neutralized by potassium hydroxide), 3.42 parts of a 4% aqueous solution of the following compound (J) (manufactured by Wako Pure Chemical Industries, Ltd.), 1.13 parts of a 4% aqueous solution of the following compound (J′) (manufactured by Wako Pure Chemical Industries, Ltd.) and 0.67 part of ion exchange water were mixed to prepare a coating solution (a) for the intermediate layer.

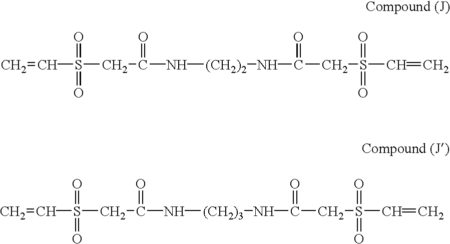

Preparation of a Coating Solution (b) for Forming an Intermediate Layer

5.0 parts of the aqueous gelatin solution for forming the intermediate layer, 2 parts of a zinc stearate dispersion (L111: Chukyo Oil & Fat Co., Ltd., fusing point: 117° C., heat of fusion: 123 J/g, particle size: 0.15 μm, solids content: 21%), 0.05 part of sodium (4-nonylphenoxytrioxyethylene)butylsulfonate (manufactured by Sankyo Chemical Industries, Ltd., 2.0% aqueous solution), 2.07 parts of boric acid (4.0% aqueous solution), 0.19 part of an aqueous solution (5%) of polystyrenesulfonic acid (partially neutralized by potassium hydroxide), 3.42 parts of a 4% aqueous solution of the above-mentioned compound (J), 1.13 parts of a 4% aqueous solution of the above-mentioned compound (J′) and 3.67 parts of ion exchange water were mixed to prepare a coating solution (b) for an intermediate layer.

Incidentally, the zinc stearate having a particle size of 1 μm or smaller was obtained by a method described in JP-A No. 2002-18254.

Further, the fusing point and heat of fusion of the above-mentioned L111 were obtained using a DSC (DSC-60A, manufactured by Simadzu Corporation: measurement was carried out at 40° C.-200° C. employing a temperature rising rate of 5° C./min). Hereinafter, the fusing point and heat of fusion or the softening point and latent heat of fusion in Examples are the values obtained using a DSC in the same manner as the fusing point and heat of fusion obtained with the above-mentioned L111.

Preparation of a Coating Solution for a Light-Transmittance Adjusting Layer

<Preparation of Microcapsule Solution Containing UV Absorbent Precursor>

To 71 parts of ethyl acetate were added 14.5 parts of [2-allyl-6-(2H-benzotriazole-2-yl)-4-t-octylphenyl benzenesulfonate as the UV absorbent precursor, 4.0 parts of 2,2′-t-octylhydroquinone, 2.9 parts of tricresyl phosphate, 5.7 parts of α-methylstyrene dimer (trade name: MSD-100, manufactured by Mitsui Chemicals Inc.), 0.45 part of calcium dodecylbenzenesulfonate (trade name: Pionin A-41-C (70% methanol solution) manufactured by Takemoto Oil & Fat Co., Ltd.) to prepare a uniform mixed solution. To the thus obtained mixed solution was added 54.7 parts of xylylene diisocyanate/trimethylolpropane adduct (trade name; Takenate D110N (75% ethyl acetate solution) manufactured by Takeda Chemical Industries, Ltd.) as a capsule wall material, and homogeneously stirred to obtain a UV absorbent precursor mixed solution.

Separately, to 52 parts of itaconic acid-modified polyvinyl alcohol (trade name: KL-318, manufactured by Kuraray Co., Ltd.) were added 8.9 parts of a 30% phosphoric acid solution and 532.6 parts of ion exchange water to prepare an aqueous PVA solution used for a microcapsule solution containing the UV absorbent precursor.

To 516.06 parts of the above-mentioned aqueous PVA solution used for the microcapsule solution containing the UV absorbent precursor was added the UV absorbent precursor mixed solution, and emulsified and dispersed at 20° C. using a homogenizer (manufactured by Nihon Seiki Seisakusho K.K.). To the resulting emulsion was added 254.1 parts of ion exchange water and thoroughly mixed, and an encapsulating reaction was effected to proceed for 3 hours with stirring at 40° C. Thereafter, to this was added 94.3 parts of ion-exchange resin Amberlite MB-3 (manufactured by Organo Corporation) and stirred for additional one hour. Then, the resultant product was filtrated to remove the ion exchange resin, after which the solids concentration was adjusted to 13.5%. The particle size of the produced microcapsules was measured (by LA-700, manufactured by Horiba Ltd.) and the median diameter was found to be 0.23±0.05 μm. 859.1 parts of this capsule solution were admixed with 2.416 parts of carboxy-modified styrene-butadiene latex (trade name: SN-307, (48% aqueous solution) manufactured by Sumitomo Naugatuck Co., Ltd.) and 39.5 parts of ion exchange water to prepare a UV absorbent precursor microcapsule solution.

<Preparation of Coating Solution for Light-Transmittance Adjusting Layer>

1,000 parts of the UV absorbent precursor microcapsule solution, 5.2 parts of a fluorine-based compound (trade name: MEGAFAC F-120 (5% aqueous solution) manufactured by Dainippon Ink and Chemicals, Incorporated), 7.75 parts of a 4% aqueous sodium hydroxide solution and 73.39 parts of sodium(4-nonylphenoxy trioxyethylene)butylsulfonate (2.0% aqueous solution, manufactured by Sankyo Chemical Industries, Ltd.) were mixed to obtain a coating solution for the light-transmittance adjusting layer.

<Preparation of Coating Solution for Protective Layer>

(Preparation of Polyvinyl Alcohol Solution for Protective Layer)

160 parts of vinyl alcohol/alkyl vinyl ether copolymer (trade name: EP-130, manufactured by Denki Kagaku Kogyo), 8.74 parts of a mixed solution of sodium alkylsulfonate and polyoxyethylene alkyletherphosphate (trade name: Neoscore CM-57 (54% aqueous solution) manufactured by Toho Chemical Industry Co., Ltd.) and 3,832 parts of ion exchange water were mixed and dissolved at 90° C. for one hour to obtain a uniform polyvinyl alcohol solution for the protective layer.

(Preparation of Pigment Dispersion for Protective Layer)

To 5 parts of barium sulfate (trade name: BF-21F having a barium sulfate content of greater than 93%, manufactured by Sakai Chemical Industry Co., Ltd.) were added 0.2 part of an anionic special polycarbonic acid-type polymer surfactant (trade name: Poise 532A (40% aqueous solution) manufactured by Kao Corporation) and 11.8 parts of ion exchange water, and subjected to dispersing operation using DYNO-Mill to prepare a barium sulfate dispersion. The particle size of this dispersion was measured (by LA-910, manufactured by Horiba Ltd.) and the median diameter was found to be smaller than 0.15 μm.

To 45.6 parts of the above-mentioned barium sulfate dispersion was added 8.1 parts of colloidal silica (trade name: SNOWTEX 0 (20% aqueous solution), manufactured by Nissan Chemical Industries, Ltd.) to obtain a pigment dispersion for a protective layer.

(Preparation of Matting Agent Dispersion for Protective Layer)

To 220 parts of wheat starch (trade name: Wheat Starch S, manufactured by Shinshin Shokuryo Kogyo) were added 3.81 parts of a dispersion of 1,2-benzisothiazoline-3-one (trade name: PROXEL manufactured by B.D., I.C.I.) and 1976.19 parts of ion exchange water, and homogeneously dispersed to obtain a matting agent dispersion for the protective layer.

(Preparation of Coating Solution for Protective Layer)

To 1,000 parts of the polyvinyl alcohol solution for the protective layer were added 40 parts of a fluorine-based surfactant (trade name: MEGAFAC F-120, 5% aqueous solution, manufactured by Dainippon Ink and Chemicals, Inc.), 50 parts of sodium(4-nonylphenoxy trioxyethylene)butylsulfonate (2.0% aqueous solution, manufactured by Sankyo Chemical Industries, Ltd.), 49.87 parts of the pigment dispersion for the protective layer, 16.65 parts of the matting agent dispersion for the protective layer and 48.7 parts of the zinc stearate dispersion (trade name: Hydrin F115, 20.5% aqueous solution, manufactured by Chukyo Oil & Fat Co., Ltd.) and thoroughly mixed to obtain a coating solution for the protective layer.

<Preparation of Support>

(Preparation of Coating Solution for Undercoat Layer)

To 60 parts of ion exchange water was added 40 parts of enzyme-decomposed gelatin (average molecular weight: 10,000; viscosity by PAGI method: 1.5 mPa·s (15 mP), jelling strength by PAGI method: 20 g), and stirred and dissolved at 40° C. to prepare an aqueous gelatin solution for the undercoat layer.

Separately, 8 parts of water-swelling synthetic mica (aspect ratio: 1000, trade name: Somashif ME100, manufactured by Co-op Chemical Co., Ltd.) was mixed with 92 parts of water, and the resultant product was wet-dispersed using a viscomill to obtain a mica dispersion having an average particle size of 2.0 μm. Water was added to this mica dispersion to bring the mica concentration to 5%, and thoroughly mixed to prepare a desired mica dispersion.

To 100 parts of a 40% coating solution for the undercoat layer were added 120 parts of water and 556 parts of methanol at 40° C. and sufficiently stirred, to which was added 208 parts of a 5% mica dispersion, and further stirred, to which was added 6.8 parts of a 1.66% polyethylene oxide-based surfactant. Then, with the solution temperature maintained at 35° C.-40° C., 7.3 parts of an epoxy compound-type gelatin hardener was added thereto to prepare a coating solution for the undercoat layer (5.7%), to thus obtain a coating solution for the undercoat layer.

(Preparation of Support Having Undercoat Layer)

Wood pulp composed of 50 parts of LBPS and 50 parts of LBPK was subjected to a beating process using a disc refiner to yield 300 ml in Canadian freeness. To the resultant product was added 0.5 part of epoxidated behenic acid amide, 1.0 part of anionic polyacrylamide, 1.0 part of aluminum sulfate, 0.1 part of polyamidepolyamine epichlorohydrin and 0.5 part of cationic polyacrylamide, each added at an absolute dried mass ratio with respect to pulp, so that base paper was formed with a basis weight of 114 g/m² using a Fourdrinier paper machine, and then calendered to give a thickness of 100 μm.

Then, after the both surfaces of the base paper had been subjected to corona discharging treatment, polyethylene was coated thereon using a melt extruder to provide a resin thickness of 36 μm to thereby form a resin layer having a matte surface (this surface is referred to as “back surface”). Then, the surface opposite to the surface coated with the resin layer was provided with polyethylene that contained 10% of anatase-type titanium dioxide and a slight amount of ultramarine blue pigment using a melt extruder to give a resin thickness of 50 μm, whereby a resin layer having a gloss surface was formed (this surface is referred to as “front surface”). After the polyethylene-resin coated back surface had been subjected to corona discharging treatment, a mixture of aluminum oxide (trade name; Alumina Sol 100, manufactured by Nissan Chemical Industries, Ltd.)/silicon dioxide (trade name; SNOWTEX O, manufactured by Nissan Chemical Industries, Ltd.)=½ (mass ratio) dispersed in water was applied thereto as an antistatic agent, to yield 0.2 g/m² by mass after dried. Next, after the polyethylene-resin coated front surface had been subjected to corona discharging treatment, the coating solution for the undercoat layer was applied thereon to provide a coated amount of mica of 0.26 g/m², whereby a support having an undercoat layer was prepared.

<Application of Respective Coating Solutions for Heat-Sensitive Recording Layers>

On the surface of the support having the undercoat layer, the following seven layers were simultaneously formed by applying successively from the bottom: a coating solution (c) for the heat-sensitive recording layer, a coating solution (b) for the intermediate layer, a coating solution (b) for the heat-sensitive recording layer, a coating solution (a) for the intermediate layer, a coating solution (a) for the heat-sensitive recording layer, a coating solution for the light-transmittance adjusting layer and a coating solution for the protective layer, and these layers are dried under conditions of 30° C. and 30% humidity and of 40° C. and 30% humidity, respectively, whereby a multi-color heat-sensitive recording material of Example 1 was produced in which an intermediate layer containing the compound according to the invention was disposed between the magenta heat-sensitive recording layer and the cyan heat-sensitive recording layer.

In this case, the coating amount of the coating solution (a) for the heat-sensitive recording layer was controlled such that the coated amount of the diazonium compound (A) present in this solution was made 0.078 g/m² as the solids content; and in the same manner, the coating amount of the coating solution (b) for the heat-sensitive recording layer was controlled such that the coated amount of the diazonium compound (D) present in this solution was made 0.206 g/m² as the solids content; and in the same manner, the coating amount of the coating solution (c) for the heat-sensitive recording layer was controlled such that the coated amount of the electron-donating dye (H) present in this solution was made 0.355 g/m² as the solids content.

Further, the coating amounts of the coating solution (b) for the intermediate layer and the coating solution (a) for the intermediate layer, as the solids content, are shown in Table 4. The coating solution for the light-transmittance adjusting layer was applied so as to give a coated amount of 2.35 g/m² as the solids content, and the coating solution for the protective layer was applied so as to give a coated amount of 1.70 g/m² as the solids content.

### Example 2

The same procedure to prepare the coating solution (b) for the intermediate layer in Example 1 was repeated, except that instead of adding 2 parts of a zinc stearate dispersion (L111), 1.6 parts of a stearic acid amid dispersion (Himicron L507: manufactured by Chukyo Oil & Fat Co., Ltd., fusing point: 98° C., heat of fusion: 162 J/g, particle size: 0.35 μm, solids content: 25%) was added to obtain a heat-sensitive recording material of Example 2.

### Example 3

The same procedure to prepare the coating solution (b) for the intermediate layer in Example 1 was followed, except that instead of adding 2 parts of a zinc stearate dispersion (L111), 1.3 parts of a polyethylene wax dispersion (POLYLON A: manufactured by Chukyo Oil & Fat Co., Ltd., softening point: 115° C., latent heat of fusion: 52 J/g, particle size: 0.15 μm, solids content: 30%) was added to produce a heat-sensitive recording material of Example 3.

### Example 4

The same procedure to prepare the coating solution (b) for the intermediate layer in Example 1 was repeated, except that instead of adding 2 parts of a zinc stearate dispersion (L111), 1.3 parts of a polyethylene wax dispersion (POLYLON 393: manufactured by Chukyo Oil & Fat Co., Ltd., softening point: 108° C., latent heat of fusion: 60 J/g, particle size: 0.15 μm, solids content: 30%) was added to give a heat-sensitive recording material of Example 4.

### Example 5

The same procedure to prepare the coating solution (b) for the intermediate layer in Example 1 was followed, except that instead of adding 2 parts of a zinc stearate dispersion (L111), 1 part of a synthetic polymer wax dispersion (CX-ST200: manufactured by Nippon Shokubai Co., Ltd., softening point: 50° C., latent heat of fusion: 87 J/g, particle size: 0.2 μm, solids content: 40%) was added to yield a heat-sensitive recording material of Example 5.

### Example 6

The same procedure to prepare the coating solution (b) for the intermediate layer in Example 1 was repeated, except that instead of adding 2 parts of a zinc stearate dispersion (L111), 1 part of a polyethylene wax dispersion (HYTEC E4A: manufactured by Toho Chemical Industry Co., Ltd., softening point: 127° C., latent heat of fusion: 132 J/g, particle size: 0.2 μm, solids content: 40%) was added to afford a heat-sensitive recording material of Example 6.

### Example 7

The same procedure to prepare the coating solution (b) for the intermediate layer in Example 1 was followed, except that instead of adding 2 parts of a zinc stearate dispersion (L111), 1.3 parts of a polypropylene wax dispersion (HYTEC E433N: manufactured by Toho Chemical Industry Co., Ltd., softening point: 143° C., latent heat of fusion: 45 J/g, particle size: 0.2 μm, solids content: 30%) was added to obtain a heat-sensitive recording material of Example 7.

### Example 8

The same procedure to prepare the coating solution (b) for the intermediate layer in Example 1 was repeated, except that instead of adding 2 parts of a zinc stearate dispersion (L111), 1.3 parts of a carnauba wax dispersion (K-375: manufactured by Chukyo Oil & Fat Co., Ltd., fusing point: 82° C., heat of fusion: 147 J/g, particle size: 0.2 μm, solids content: 30%) was added to produce a heat-sensitive recording material of Example 8.

### Example 9

The same procedure to prepare the coating solution (b) for the intermediate layer in Example 1 was followed, except that instead of adding 2 parts of a zinc stearate dispersion (L111), 1.3 parts of a polyethylene wax dispersion (L-618: manufactured by Chukyo Oil & Fat Co., Ltd., softening point: 124° C., latent heat of fusion 138 J/g, particle size: 0.15 μm, solids content: 30%) was added to give a heat-sensitive recording material of Example 9.

### Example 10

The same procedures of applying the respective coating solutions for the heat-sensitive recording layers in Example 1 were carried out, except that the following changes were made: on the surface of the support having the undercoat layer, the following seven layers were simultaneously formed by successively applying from the bottom: the coating solution (c) for the heat-sensitive recording layer, the coating solution (a) for the intermediate layer, the coating solution (b) for the heat-sensitive recording layer, the coating solution (b) for the intermediate layer, the coating solution (a) for the heat-sensitive recording layer, the coating solution for the light-transmittance adjusting layer and the coating solution for the protective layer, and that the coating amounts as solids content of the coating solution (b) for the intermediate layer and the coating solution (a) for the intermediate layer were changed to the coating amounts shown in Table 4, whereby a heat-sensitive recording material of Example 10 was produced in which an intermediate layer containing the compound according to the invention was disposed between the yellow heat-sensitive recording layer and the magenta heat-sensitive recording layer.

### Example 11

The same procedure to prepare the coating solution (b) for the intermediate layer in Example 10 was repeated, except that instead of adding 2 parts of a zinc stearate dispersion (L111), 1.6 parts of a stearic acid amid dispersion (Himicron L507: manufactured by Chukyo Oil & Fat Co., Ltd., fusing point: 98° C., heat of fusion: 162 J/g, particle size: 0.35 μm, solids content: 25%) was added to obtain a heat-sensitive recording material of Example 11.

### Example 12

The same procedure to prepare the coating solution (b) for the intermediate layer in Example 10 was followed, except that instead of adding 2 parts of a zinc stearate dispersion (L111), 1.3 parts of a polyethylene wax dispersion (POLYLON A: manufactured by Chukyo Oil & Fat Co., Ltd., softening point: 115° C., latent heat of fusion: 52 J/g, particle size: 0.15 μm, solids content: 30%) was added to produce a heat-sensitive recording material of Example 12.

### Example 13

The same procedure to prepare the coating solution (b) for the intermediate layer in Example 10 was repeated, except that instead of adding 2 parts of a zinc stearate dispersion (L111), 1.3 parts of a polyethylene wax dispersion (POLYLON 393: manufactured by Chukyo Oil & Fat Co., Ltd., softening point: 108° C., latent heat of fusion: 60 J/g, particle size: 0.15 μm, solids content: 30%) was added to give a heat-sensitive recording material of Example 13.

### Example 14

The same procedure to prepare the coating solution (b) for the intermediate layer in Example 10 was followed, except that instead of adding 2 parts of a zinc stearate dispersion (L111), 1 part of a synthetic polymer wax dispersion (CX-ST200: manufactured by Nippon Shokubai Co., Ltd., softening point: 50° C., latent heat of fusion: 87 J/g, particle size: 0.2 μm, solids content: 40%) was added to yield a heat-sensitive recording material of Example 14.

### Example 15

The same procedure to prepare the coating solution (b) for the intermediate layer in Example 10 was repeated, except that instead of adding 2 parts of a zinc stearate dispersion (L111), 1 part of a polyethylene wax dispersion (HYTEC E4A: manufactured by Toho Chemical Industry Co., Ltd., softening point: 127° C., latent heat of fusion: 132 J/g, particle size: 0.2 μm, solids content: 40%) was added to afford a heat-sensitive recording material of Example 15.

### Example 16

The same procedure to prepare the coating solution (b) for the intermediate layer in Example 10 was followed, except that instead of adding 2 parts of a zinc stearate dispersion (L111), 1.3 parts of a polypropylene wax dispersion (HYTEC E433N: manufactured by Toho Chemical Industry Co., Ltd., softening point: 143° C., latent heat of fusion: 45 J/g, particle size: 0.2 μm, solids content: 30%) was added to obtain a heat-sensitive recording material of Example 16.

### Example 17

The same procedure to prepare the coating solution (b) for the intermediate layer in Example 10 was repeated, except that instead of adding 2 parts of a zinc stearate dispersion (L111), 1.3 parts of a carnauba wax dispersion (K-375: manufactured by Chukyo Oil & Fat Co., Ltd., fusing point: 82° C., heat of fusion: 147 J/g, particle size: 0.2 μm, solids content: 30%) was added to produce a heat-sensitive recording material of Example 17.

### Example 18

The same procedure to prepare the coating solution (b) for the intermediate layer in Example 10 was followed, except that instead of adding 2 parts of a zinc stearate dispersion (L111), 1.3 parts of a polyethylene wax dispersion (L-618: manufactured by Chukyo Oil & Fat Co., Ltd., fusing point: 124° C., latent heat of fusion 138 J/g, particle size: 0.15 μm, solids content: 30%) was added to give a heat-sensitive recording material of Example 18.

### Comparative Example 1

The same procedure to prepare the coating solution (b) for the intermediate layer in Example 10 was repeated, except that instead of adding 2 parts of a zinc stearate dispersion (L111), 1.3 parts of a zinc stearate dispersion (Hydrin Z-7: manufactured by Chukyo Oil & Fat Co., Ltd., solids content: 30%, particle size: 5 μm) was added to yield a heat-sensitive recording material of Comparative Example 1.

### Comparative Example 2

The same procedures of applying the respective coating solutions for the heat-sensitive recording layers in Example 1 were carried out, except that the following changes were made: on the surface of the support having the undercoat layer, the following seven layers were simultaneously formed by successively applying from the bottom: the coating solution (c) for the heat-sensitive recording layer, the coating solution (a) for the intermediate layer, the coating solution (b) for the heat-sensitive recording layer, the coating solution (a) for the intermediate layer, the coating solution (a) for the heat-sensitive recording layer, the coating solution for the light-transmittance adjusting layer and the coating solution for the protective layer, and that the coating amounts as solids content of the coating solution (a) for the intermediate layer disposed between the magenta heat-sensitive recording layer and the cyan heat-sensitive recording layer, and the coating solution (a) for the intermediate layer disposed between the yellow heat-sensitive recording layer and the magenta heat-sensitive recording layer were changed to the coating amounts shown in Table 4, whereby a heat-sensitive recording material of Comparative Example 2 was produced.

### Comparative Example 3

The same procedures of Comparative Example 2 were carried out, except that the coating amounts as solids content of the coating solution (a) for the intermediate layer disposed between the magenta heat-sensitive recording layer and the cyan heat-sensitive recording layer, and the coating solution (a) for the intermediate layer disposed between the yellow heat-sensitive recording layer and the magenta heat-sensitive recording layer were changed to the coating amounts shown in Table 4, whereby a heat-sensitive recording material of Comparative Example 3 was obtained.

### Comparative Example 4

The same procedures of Comparative Example 2 were carried out, except that the coating amounts as solids content of the coating solution (a) for the intermediate layer disposed between the magenta heat-sensitive recording layer and the cyan heat-sensitive recording layer, and the coating solution (a) for the intermediate layer disposed between the yellow heat-sensitive recording layer and the magenta heat-sensitive recording layer were changed to the coating amounts shown in Table 4, whereby a heat-sensitive recording material of Comparative Example 4 was produced.

<Evaluation of Sensitivity>

A test pattern was printed using a Printpix Printer NC-600 (manufactured by Fuji Photo Film Co., Ltd.) and the 128th gradation (5th step) of the yellow, magenta and cyan test patterns, respectively, were evaluated for color density. Table 4 summarizes the obtained results.

<Evaluation of Film Thickness of Intermediate Layer>

Since the density of the intermediate layer was substantially constant, the thickness of the intermediate layer could be estimated by the applied amounts of the coating solution for the intermediate layer. In other words, the smaller the applied amount of the coating solution for the intermediate layer, the thinner the intermediate layer. Table 4 shows the applied amounts of the coating solution for the intermediate layer.

TABLE 4

| | | | | Fusing | Heat of | | | Coating amount | | | |
|---|---|---|---|---|---|---|---|---|---|---|---|
| | | | | point or | fusion or | | | of Intermediate | | | |
| | Name of | Solids | Addition | Softening | Latent heat | Particle | Disposed | Layer between | | | |
| | added | Concentra- | Amount | point | of fusion | Size | between | Layers (g/m²) | | M5 | C5 |
| | Compound | tion (%) | (parts) | (° C.) | (J/g) | (μm) | Layers | M-C | Y-M | Density | Density |
| Example | L111 | 21 | 2 | 117 | 123 | 0.15 | M-C | 2.55 | 2.4 | — | 0.63 |
| 1 | | | | | | | | | | | |
| Example | Himicron | 25 | 1.6 | 98 | 162 | 0.35 | M-C | 2.55 | 2.4 | — | 0.64 |
| 2 | L507 | | | | | | | | | | |
| Example | POLYLON A | 30 | 1.3 | 115 | 52 | 0.15 | M-C | 2.55 | 2.4 | — | 0.55 |
| 3 | | | | | | | | | | | |
| Example | POLYLON | 30 | 1.3 | 108 | 60 | 0.15 | M-C | 2.55 | 2.4 | — | 0.48 |
| 4 | 393 | | | | | | | | | | |
| Example | CX-ST200 | 40 | 1 | 50 | 87 | 0.2 | M-C | 2.55 | 2.4 | — | 0.65 |
| 5 | | | | | | | | | | | |
| Example | HYTEC | 40 | 1 | 127 | 132 | 0.2 | M-C | 2.55 | 2.4 | — | 0.54 |
| 6 | E4A | | | | | | | | | | |
| Example | HYTEC | 30 | 1.3 | 143 | 45 | 0.2 | M-C | 2.55 | 2.4 | — | 0.54 |
| 7 | E433N | | | | | | | | | | |
| Example | K-375 | 30 | 1.3 | 82 | 147 | 0.2 | M-C | 2.55 | 2.4 | — | 0.56 |
| 8 | | | | | | | | | | | |
| Example | L-618 | 30 | 1.3 | 124 | 138 | 0.15 | M-C | 2.55 | 2.4 | — | 0.56 |
| 9 | | | | | | | | | | | |
| Example | L111 | 21 | 2 | 117 | 123 | 0.15 | Y-M | 3.4 | 1.8 | 0.44 | 0.58 |
| 10 | | | | | | | | | | | |
| Example | Himicron | 25 | 1.6 | 98 | 162 | 0.35 | Y-M | 3.4 | 1.8 | 0.48 | 0.60 |
| 11 | L507 | | | | | | | | | | |
| Example | POLYLON A | 30 | 1.3 | 115 | 52 | 0.15 | Y-M | 3.4 | 1.8 | 0.49 | 0.57 |
| 12 | | | | | | | | | | | |
| Example | POLYLON | 30 | 1.3 | 108 | 60 | 0.15 | Y-M | 3.4 | 1.8 | 0.45 | 0.56 |
| 13 | 393 | | | | | | | | | | |
| Example | CX-ST200 | 40 | 1 | 50 | 87 | 0.2 | Y-M | 3.4 | 1.8 | 0.46 | 0.50 |
| 14 | | | | | | | | | | | |
| Example | HYTEC | 40 | 1 | 127 | 132 | 0.2 | Y-M | 3.4 | 1.8 | 0.46 | 0.51 |
| 15 | E4A | | | | | | | | | | |
| Example | HYTEC | 30 | 1.3 | 143 | 45 | 0.2 | Y-M | 3.4 | 1.8 | 0.51 | 0.64 |
| 16 | E433N | | | | | | | | | | |
| Example | K-375 | 30 | 1.3 | 82 | 147 | 0.2 | Y-M | 3.4 | 1.8 | 0.47 | 0.51 |
| 17 | | | | | | | | | | | |
| Example | L-1618 | 30 | 1.3 | 124 | 138 | 0.15 | Y-M | 3.4 | 1.8 | 0.45 | 0.63 |
| 18 | | | | | | | | | | | |

| | | | | | | | | | | |
|---|---|---|---|---|---|---|---|---|---|---|
| Compara- | Hydrin Z-7 | 30 | 1.3 | — | — | 5 | Y-M | 3.4 | 1.8 | Defective surface |
| tive | | | | | | | | | | state |
| Example | | | | | | | | | | |
| 1 | | | | | | | | | | |

| | | | | | | | | | | | |
|---|---|---|---|---|---|---|---|---|---|---|---|
| Compara- | None | — | — | — | — | — | — | 3.4 | 2.4 | 0.49 | 0.66 |
| tive | | | | | | | | | | | |
| Example | | | | | | | | | | | |
| 2 | | | | | | | | | | | |
| Compara- | None | — | — | — | — | — | — | 2.55 | 2.4 | — | 0.76 |
| tive | | | | | | | | | | | |
| Example | | | | | | | | | | | |
| 3 | | | | | | | | | | | |
| Compara- | None | — | — | — | — | — | — | 3.4 | 1.8 | 0.55 | 0.74 |
| tive | | | | | | | | | | | |
| Example | | | | | | | | | | | |
| 4 | | | | | | | | | | | |

*In the Table, Y represents a yellow layer, M represents a magenta layer and C represents a cyan layer, and each of M5 density and C5 density represents the density of the 128th gradation (5^{th} step) of the magenta layer and the cyan layer, respectively.

Table 4 shows that although the heat-sensitive recording materials of Examples 1 to 18 had a thinner intermediate layer, these materials exhibited the same level of sensitivity as that of the heat-sensitive recording material of Comparative Example 2 provided with an intermediate layer having an ordinary thickness, to thus reveal that the respective heat-sensitive recording layers are well-balanced.

Table 4 also shows that the heat-sensitive recording materials of Comparative Examples 3 and 4 could not exhibit the same level of sensitivity as that of the heat-sensitive recording material of Comparative Example 2 when the layer was simply made thinner. It further shows that the heat-sensitive recording material of Comparative Example 1 obtained using a compound having a particle size exceeding 1 μm had a defective surface state, that is, the coated surface state was not good.

As detailed above, the present invention provides a heat-sensitive recording material that achieves a reduction in cost by making the intermediate layer thinner and properly maintains the sensitivity of a heat-sensitive recording layer disposed under the intermediate layer.

What is claimed is:

1. A heat-sensitive recording material comprising a support having disposed thereon at least two heat-sensitive recording layers and an intermediate layer provided between the heat-sensitive recording layers,
wherein the intermediate layer contains a compound having a fusing point or a softening point ranging from 40° C. to 200° C. and a particle size of 0.5 μm or smaller.

2. The heat-sensitive recording material according to claim 1, wherein the compound has a fusing point or a softening point ranging from 80° C. to 200° C.

3. The heat-sensitive recording material according to claim 1, wherein the compound has a fusing point or a softening point ranging from 100° C. to 150° C.

4. The heat-sensitive recording material according to claim 1, wherein the compound has a heat of fusion or a latent heat of fusion of 80 J/g or greater.

5. The heat-sensitive recording material according to claim 1, wherein the compound has a heat of a fusion or a latent heat of fusion of 100 J/g or greater.

6. The heat-sensitive recording material according to claim 1, wherein the compound is zinc stearate.

7. The heat-sensitive recording material according to claim 1, wherein the compound is polyethylene wax having a softening point of 100° C. or higher.

8. The heat-sensitive recording material according to claim 1, wherein the intermediate layer contains a binder.

9. The heat-sensitive recording material according to claim 8, wherein the binder is selected from the group consisting of gelatin, a water-soluble polymer, a synthetic rubber latex and a synthetic resin emulsion.

10. The heat-sensitive recording material according to claim 8, wherein the compound is contained in an amount of 10 to 200% by mass relative to the binder.

11. The heat-sensitive recording material according to claim 8, wherein the compound is contained in an amount of 20 to 100% by mass relative to the binder.

12. The heat-sensitive recording material according to claim 8, wherein the intermediate layer further contains at least one selected from the group consisting of a pigment, a lubricant, a surfactant, a dispersant, a fluorescent brightener, a metal soap, a UV absorbent and a crosslinking agent.

13. The heat-sensitive recording material according to claim 1, wherein the intermediate layer has a coated amount after drying of 1 to 5 g/m².

14. The heat-sensitive recording material according to claim 1, wherein the intermediate layer has a coated amount after drying of 1.5 to 3 g/m².

15. The heat-sensitive recording material according to claim 1, wherein the heat-sensitive recording layers comprise a photofixation-type heat-sensitive recording layer containing a diazonium salt compound having a maximum absorption wavelength of 365±40 nm and a coupler capable of reacting with the diazonium salt compound to develop color, and another photofixation-type heat-sensitive recording layer containing another diazonium salt compound having a maximum absorption wavelength of 425±40 nm and another coupler capable of reacting with the another diazonium salt compound to develop color.

16. The heat-sensitive recording material according to claim 1, wherein the heat-sensitive recording layers comprise a photofixation-type heat-sensitive recording layer containing a diazonium salt compound having a maximum absorption wavelength of less than 380 nm and a coupler capable of reacting with the diazonium salt compound to develop color, and another photofixation-type heat-sensitive recording layer containing another diazonium salt compound having a maximum absorption wavelength exceeding 390 nm and another coupler capable of reacting with the another diazonium salt compound to develop color.

17. The heat-sensitive recording material according to claim 1, further comprising a light-transmittance adjusting layer.

18. The heat-sensitive recording material according to claim 1, further comprising a protective layer on a surface of the heat-sensitive recording layers.

19. The heat-sensitive recording material according to claim 1, wherein the support is selected from the group consisting of polyethylene terephthalate (PET), polyethylene naphthalate (PEN), triacetyl cellulose (TAC), paper, plastic resin laminated paper and synthetic paper.
